(19) United States
(12) Patent Application Publication
(10) Pub. No.: US 2026/0185397 A1
(43) Pub. Date: Jul. 2, 2026

(54) VACUUM INSULATED PANEL WITH GLASS FOR SEAL MATERIAL TO IMPROVE PERFORMANCE AND METHOD OF MAKING SAME

(71) Applicant: LuxWall, Inc., Ypsilanti, MI (US)

(72) Inventors: Srinivasan SRIDHARAN, Strongsville, OH (US); Enos Ayers AXTELL, III, Belleville, MI (US); Scott V. THOMSEN, Glen Arbor, MI (US); Prabhu MEGHARAJ, Novi, MI (US); Nathan P. MELLOTT, Grand Blanc, MI (US)

(21) Appl. No.: 19/211,546

(22) Filed: May 19, 2025

Related U.S. Application Data
(60) Provisional application No. 63/740,422, filed on Dec. 31, 2024.

(51) Int. Cl. E06B 3/66; E06B 3/663; E06B 3/677

(52) U.S. Cl. CPC E06B 3/6612; E06B 3/66342; E06B 3/6775; E06B 2003/66338

(57) ABSTRACT

A vacuum insulating panel may include: a first glass substrate; a second glass substrate; a plurality of spacers provided in a gap between at least the first and second substrates, wherein the gap is at a pressure less than atmospheric pressure; and a seal (e.g., edge seal and/or pump-out tube seal) having at least a first seal layer. In order to form a layer of the seal, a glass may be provided such as in a paste which may also include filler, binder and/or solvent, or in a pressed preform which may also include filler. The glass (e.g., the glass, such as glass powder, present in a paste before firing) for use in forming the seal layer may include tellurium oxide and may be designed to have little or no aluminum oxide and/or little or no zinc oxide.

### RELATED APPLICATIONS

This application claims priority on U.S. Provisional Patent Application No. 63/740,422, filed Dec. 31, 2024, the disclosure of which is hereby incorporated herein by reference in its entirety.

This application is also related to U.S. application Ser. Nos. 19/192,492, filed Apr. 29, 2025, and Ser. No. 19/206,313 filed May 13, 2025, the disclosures of which are hereby incorporated herein by reference in their entireties.

### FIELD

Certain example embodiments are generally related to vacuum insulated devices such as vacuum insulating panels that may be used for windows or the like, to a glass composition for use in forming a seal for vacuum insulating panels, and/or methods of making vacuum insulating panels using such a glass composition.

### BACKGROUND AND SUMMARY

Vacuum insulated panels are known in the art. For example, and without limitation, vacuum insulating panels are disclosed in U.S. Pat. Nos. 5,124,185, 5,657,607, 5,664,395, 7,045,181, 7,115,308, 8,821,999, 10,153,389, 11,124,450, 2024/0167320, and 2024/0167324, the disclosures of which are all hereby incorporated herein by reference in their entireties.

As discussed and/or shown in one or more of the above patent documents, a vacuum insulating panel typically includes an outboard substrate, an inboard substrate, a hermetic edge seal, a sorption getter, a pump-out port, and spacers (e.g., pillars) sandwiched between at least the two substrates. The gap between the substrates may be at a pressure less than atmospheric pressure to provide insulating properties. Providing a vacuum in the space between the substrates reduces conduction and convection heat transport, and thus provides insulating properties. For example, a vacuum insulating panel may provide thermal insulation resistance by reducing convective energy between the two substrates, reducing conductive energy between the two transparent substrates, and reducing radiative energy with a low-emissivity (low-E) coating provided on a substrate. Vacuum insulating panels may be used in window applications (e.g., for commercial and/or residential windows), and/or for other applications such as commercial refrigeration and consumer appliance applications.

U.S. Pat. No. 10,745,317 discloses a base glass composition for use in forming a seal for a vacuum insulating panel. The base glass composition of the '317 patent is:

| Component | wt. % |
|---|---|
| TeO₂ | 40-61% |
| V₂O₅ | 9-40% |
| Al₂O₃ | 5-20% |

In making a seal for a vacuum insulating panel, the '317 patent explains that the above base glass composition may be combined with a high temperature bismuth-based glass, a reactive oxide (e.g., Y₂O₃, La₂O₃, Bi₂O₃, SiO₂, ZrO₂, Nb₂O₅, and combinations thereof), a filler (e.g., cordierite and/or eucryptite), a binder and a solvent, with the resulting composite being used to form a seal in a vacuum insulating panel.

It has been found that large amounts of Al₂O₃ in the base glass composition of the '317 patent can lead to an elevated softening point of the glass. The higher the softening point of the glass, the more de-tempering of glass which may occur during sintering in the seal-forming process. Aluminum oxide also has significant solubility from glass into alkaline solutions, thereby leading to suspect alkaline durability in certain situations. Thus, it has been found that such large amounts of Al₂O₃ in the base glass composition (irrespective of filler which may include oxide(s) of Si and/or Al for example) may be undesirable in certain situations.

Similarly, U.S. Pat. No. 10,153,389 discloses a base glass composition for use in forming a seal for a vacuum insulating panel. The base glass composition of the '389 patent is:

| Component | mol % |
|---|---|
| TeO₂ | 40-89% |
| V₂O₅ | 5-54% |
| and at least one of: | |
| ZnO | 38-52% |
| Al₂O₃ | 6-25% |

In making a seal for a vacuum insulating panel, the '389 patent explains that the above base glass composition may be combined with another glass (e.g., Te-glass, V-glass, Bi-glass, Zn-glass, Ba-glass, or alkali-Ti-silicate glass), a filler (e.g., cordierite, beta eucryptite/eucryptite, zirconyl phosphates, dizirconium diorthophosphate, or aluminum phosphate, alone or in combination), binder (e.g., polypropylene carbonate), and a solvent, with the resulting composite/paste being used to form a seal in a vacuum insulating panel.

It has been found that large amounts of ZnO and Al₂O₃ in the base glass composition of the '389 patent can lead to an elevated softening point of the glass. The higher the softening point of the glass, the more de-tempering of glass substrate(s) which may occur during sintering of the vacuum insulating panel seal-forming process. Zinc oxide and aluminum oxide also have significant solubility from glass into alkaline solutions, thereby leading to suspect alkaline durability in certain situations. Thus, it has been found that such large amounts of ZnO and Al₂O₃ in the base glass composition (irrespective of filler for example, which may include oxide(s) of Si and/or Al for example) may be undesirable in certain situations.

In certain example embodiments, the base glass composition prior to firing (e.g., the glass, such as glass powder, present in a paste before firing, or present in a pre-form before firing), exclusive of any filler, for use in forming a seal in a vacuum insulated panel may include tellurium oxide (e.g., TeO₂, TeO₃, TeO₄, other suitable stoichiometry, and/or combinations thereof) and may be designed to have little or no aluminum oxide (e.g., Al₂O₃ or other suitable stoichiometry) and/or little or no zinc oxide (e.g., ZnO or other suitable stoichiometry). For example, tellurium oxide may be the largest metal oxide component, in terms of magnitude with respect to wt. % and/or mol %, in the pre-sintering base glass composition in certain example embodiments. In certain example embodiments, the pre-sintering base glass composition may comprise from about 0-4% (more preferably from about 0-3%, more preferably from about 0-2%, more preferably from about 0-1%, and most preferably from about 0-0.5%) aluminum oxide; and/or from about 0-4% (more preferably from about 0-3%, more preferably from about 0-2%, more preferably from about 0-1%, and most preferably from about 0-0.5%) zinc oxide, in terms of wt. % and/or mol %. Advantageously, this allows the glass composition to realize a lower softening point, which can lead to less de-tempering of glass substrate(s) of the panel during heating (e.g., via laser and/or otherwise) involved in seal formation.

In certain example embodiments, the base glass composition, exclusive of any filler, may also include at least one of: copper oxide, bismuth oxide, titanium oxide, lanthanum oxide, manganese oxide, boron oxide, and/or any combination thereof.

In certain example embodiments, the glass may be substantially free (no more than about 1%, more preferably no more than about 0.5%, wt. % or mol %) of and/or free of bismuth oxide, in order to reduce a Labino softening point of the glass for example.

In certain example embodiments, the glass may be initially provided as part of a paste (e.g., for use in forming a seal layer of an edge seal), wherein the paste may also include a filler and optionally a binder and/or solvent. The glass may also initially be provided as part of a pre-form, for use in forming a seal such as a pump-out tube seal. In certain example embodiments, filler (one or more filler(s)) may be of or include amorphous or substantially amorphous material, such as amorphous or substantially amorphous silica, amorphous or substantially amorphous borosilicate glass, and/or amorphous or substantially amorphous lithia-aluminosilicate glass. The use of amorphous or substantially amorphous material (e.g., amorphous or substantially amorphous silica, amorphous or substantially amorphous borosilicate glass, and/or amorphous or substantially amorphous lithia-aluminosilicate glass) in filler is technically advantageous in that amorphous or substantially amorphous silica, amorphous or substantially amorphous borosilicate glass, and/or amorphous or substantially amorphous lithia-aluminosilicate glass are low expansion material(s) and help grade the CTE values of the seal layers relative to the glass substrates in a desirable manner.

In certain example embodiments, there may be provided a method of making a vacuum insulating panel, the vacuum insulating panel comprising a first substrate, a second substrate, a plurality of spacers provided in a gap between at least the first and second substrates, and a seal provided at least partially between at least the first and second substrates, the seal comprising a seal layer; wherein the method may comprise: providing glass in a location between at least the first and second substrates, the glass to be used in forming the seal layer, and wherein the glass comprises: tellurium oxide: from about 10-80 mol %; aluminum oxide: from about 0-0.5 mol %; zinc oxide: from about 0-10 mol %; tungsten oxide: from about 0-0.5 mol %; molybdenum oxide: from about 0-0.5 mol %; bismuth oxide: from about 0-3 mol % (more preferably from about 0-1 mol. %, more preferably from about 0-0.5 mol %); wherein the glass may have a Labino softening point (Tₛ) of less than 345 degrees C. (more preferably less than 330 degrees C.), heating the glass in order to form the seal layer; and after forming the seal, evacuating the gap to a pressure less than atmospheric pressure.

In certain example embodiments, there may be provided a method of making a vacuum insulating panel, the vacuum insulating panel comprising a first substrate, a second substrate, a plurality of spacers provided in a gap between at least the first and second substrates, and a seal provided at least partially between at least the first and second substrates, the seal comprising a seal layer; wherein the method may comprise: providing glass (e.g., a base glass) in a location between at least the first and second substrates, the glass to be used in forming the seal layer, and wherein the glass comprises:
tellurium oxide: from about 10-80 mol %;
aluminum oxide: from about 0-0.5 mol %;
zinc oxide: from about 0-10 mol %, more preferably from about 0-5 mol % or 0-4 mol %;
tungsten oxide: from about 0-0.5 mol %;
molybdenum oxide: from about 0-0.5 mol %;
   heating the glass in order to form the seal layer; and after forming the seal, evacuating the gap to a pressure less than atmospheric pressure.

In certain example embodiments, there may be provided a paste for use in forming a seal layer of a vacuum insulating panel, the paste comprising: filler and glass, wherein the glass comprises:
tellurium oxide: from about 10-80 mol %;
aluminum oxide: from about 0-4 mol %, more preferably from about 0-2 mol %, more preferably from about 0-1 mol %, more preferably from about 0-0.5 mol %;
zinc oxide: from about 0-10 mol %, more preferably from about 0-4 mol %;
   wherein the filler comprises at least one of cordierite, or amorphous and/or substantially amorphous material (e.g., amorphous and/or substantially amorphous silica, amorphous or substantially amorphous borosilicate glass particles, or a combination thereof). The paste may also include solvent and/or binder.

In certain example embodiments, there may be provided glass (e.g., a base glass) for use in forming a seal layer of a vacuum insulating panel, the glass comprising:
tellurium oxide: from about 10-80 mol %;
aluminum oxide: from about 0-0.5 mol %;
zinc oxide: from about 0-10 mol %, more preferably from about 0-4 mol %;
tungsten oxide: from about 0-0.5 mol %; and
molybdenum oxide: from about 0-0.5 mol %.

In certain example embodiments, there may be provided a vacuum insulating panel comprising: a first substrate; a second substrate; a plurality of spacers provided in a gap between at least the first and second substrates, wherein the gap is at pressure less than atmospheric pressure; a seal provided at least partially between at least the first and second substrates, the seal comprising a first seal layer; wherein the first seal layer comprises tellurium oxide, wherein the tellurium oxide has the highest mol % of any metal oxide in the first seal layer, the tellurium oxide comprising TeO₄ and TeO₃; and wherein the first seal layer may further comprises at least one of: from about 0-4 mol %, more preferably from about 0-2 mol %, more preferably from about 0-1 mol %, more preferably from about 0-0.5 mol %, aluminum oxide; from about 0-10 mol %, more preferably from about 0-4 mol %, more preferably from about 0-2 mol %, more preferably from about 0-1 mol %, more preferably from about 0-0.5 mol %, zinc oxide; from about 0.5-40%, more preferably from about 1-25%, more preferably from about 4-22%, more preferably from about 5-15% copper oxide, in terms of mol %; from about 0.5-30%, more preferably from about 1-25%, more preferably from about 3-22%, more preferably from about 6-18% bismuth oxide, in terms of mol %; from about 1-30%, more preferably from about 1-25%, more preferably from about 3-22%, more preferably from about 6-20%, more preferably from about 9-15% lanthanum oxide, in terms of mol %; from about 1-20%, more preferably from about 1-15%, more preferably from about 3-15%, more preferably from about 3-10% yttrium oxide, in terms of mol %; from about 1-40%, more preferably from about 1-25%, more preferably from about 4-22%, more preferably from about 5-15% manganese oxide, in terms of mol %; from about 4-45 mol % vanadium oxide, the vanadium oxide including VO₂ and V₂O₅, and wherein more V in the first seal layer is in a form of VO₂ than V₂O₅; from about 0.5-30%, more preferably from about 1-25%, more preferably from about 3-25%, more preferably from about 5-20%, more preferably from about 6-15% titanium oxide, in terms of mol %; from about 0.5-30%, more preferably from about 1-25%, more preferably from about 3-25%, more preferably from about 5-20%, more preferably from about 6-15% zirconium oxide and/or niobium oxide, in terms of mol %; from about 1-20%, more preferably from about 1-15%, more preferably from about 3-15%, more preferably from about 2-10% boron oxide, in terms of mol %; the tellurium oxide comprising TeO₄ and TeO₃, and wherein the first seal layer comprises more TeO₃ than TeO₄ in terms of mol %; and/or any combination thereof.

In certain example embodiments, there may be provided a vacuum insulating panel comprising: a first substrate; a second substrate; a plurality of spacers provided in a gap between at least the first and second substrates, wherein the gap is at pressure less than atmospheric pressure; a seal provided at least partially between at least the first and second substrates, the seal comprising a first seal layer; wherein the first seal layer comprises tellurium oxide, wherein the tellurium oxide has the highest mol % of any metal oxide in the first seal layer, the tellurium oxide comprising TeO₄ and TeO₃, and wherein the first seal layer comprises more TeO₃ than TeO₄ in terms of mol %; and wherein the first seal layer further comprises at least one of: from about 0.5-40%, more preferably from about 1-25%, more preferably from about 4-22%, more preferably from about 5-15% copper oxide, in terms of mol %; from about 0.5-30%, more preferably from about 1-25%, more preferably from about 3-22%, more preferably from about 6-18% bismuth oxide, in terms of mol %; from about 1-30%, more preferably from about 1-25%, more preferably from about 3-22%, more preferably from about 6-20%, more preferably from about 9-15% lanthanum oxide, in terms of mol %; from about 1-20%, more preferably from about 1-15%, more preferably from about 3-15%, more preferably from about 3-10% yttrium oxide, in terms of mol %; from about 1-40%, more preferably from about 1-25%, more preferably from about 4-22%, more preferably from about 5-15% manganese oxide, in terms of mol %; from about 4-45 mol % vanadium oxide, the vanadium oxide including VO₂ and V₂O₅, and wherein more V in the first seal layer is in a form of VO₂ than V₂O₅; from about 0.5-30%, more preferably from about 1-25%, more preferably from about 3-25%, more preferably from about 5-20%, more preferably from about 6-15% titanium oxide, in terms of mol %; from about 0-20%, more preferably from about 1-15%, more preferably from about 3-15%, more preferably from about 2-10% boron oxide, in terms of mol %; and/or any combination thereof.

In certain example embodiments, there may be provided a glass (e.g., a base glass) for use in forming a seal layer of a vacuum insulating panel, the glass comprising:
tellurium oxide: from about 10-80 mol %; and
at least one of:
   (a) aluminum oxide: from about 0-4 mol %, more preferably from about 0-2 mol %, more preferably from about 0-1 mol %, more preferably from about 0-0.5 mol %;
   (b) zinc oxide: from about 0-10 mol %; more preferably from about 0-4 mol %, more preferably from about 0-2 mol %, more preferably from about 0-1 mol % or 0-0.5 mol %;
   (c) vanadium oxide: from about 5-58 mol %;
   (d) copper oxide: from about 0.5%-40%, more preferably from about 1-40%, more preferably from about 1-25%, more preferably from about 4-25%, more preferably from about 5-22%, more preferably from about 5-15%;
   (e) tungsten oxide: from about 0-0.5 mol %;
   (f) molybdenum oxide: from about 0-0.5 mol %; and
   (g) any combination of (a)-(f);
      wherein the glass (e.g., base glass) may have a Labino softening point (Tₛ) of less than 345 degrees C., more preferably less than 335 degrees C., more preferably less than 330 degrees C., more preferably less than 326 degrees C., more preferably less than 320 degrees C., more preferably less than 315 degrees C.; and wherein the glass may have a ratio LSPT/DSPT, of the Labino softening point (LSPT) to the Dilatometric softening point (DSPT), in degrees C., from about 1.05 to 1.45, more preferably from about 1.05 to 1.40, more preferably from about 1.05 to 1.25, more preferably from about 1.05 to 1.20, more preferably from about 1.108 to 1.17, and most preferably from about 1.10 to 1.15.

Technical advantage(s), for example, may include one or more of: the glass composition prior to firing (e.g., the glass, such as glass powder, present in a paste before firing) realizing a low Labino softening point which can lead to less de-tempering of glass substrate(s) of the panel during heating (e.g., via laser and/or otherwise) involved in seal formation; improved alkaline durability of the edge seal; improved CTE grading of the seal layer(s) relative to the glass substrate(s); improved heat transfer through material(s) during manufacturing; improved U-value performance; reduced improved lamination at seal interface(s), improved seal durability, and/or less seal defects.

### BRIEF DESCRIPTION OF THE DRA WINGS

These and/or other aspects, features, and/or advantages will become apparent and more readily appreciated from the following description of various example embodiments, taken in conjunction with the accompanying drawings. Thicknesses of layers/elements, and sizes of components/elements, are not necessarily drawn to scale or in actual proportion to one another, but rather are shown as example representations. Like reference numerals may refer to like parts throughout the several views. Each embodiment herein may be used in combination with any other embodiment(s) described herein.

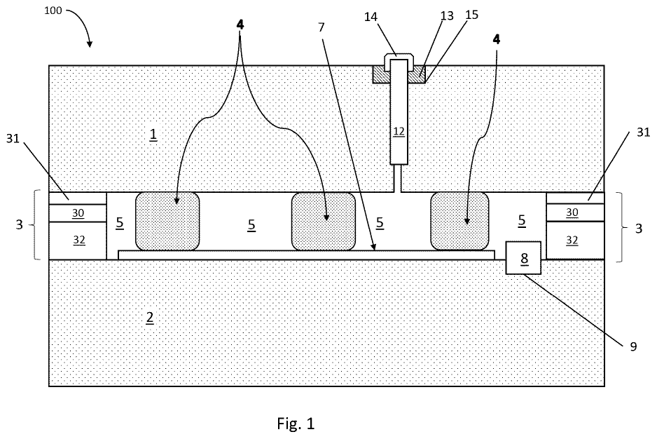

FIG. 1 is a side cross sectional view of a vacuum insulating unit/panel according to an example embodiment.

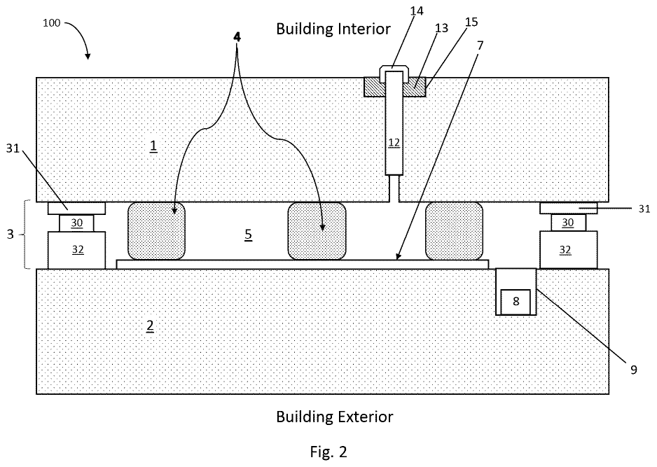

FIG. 2 is a side cross sectional view of a vacuum insulating unit/panel according to an example embodiment.

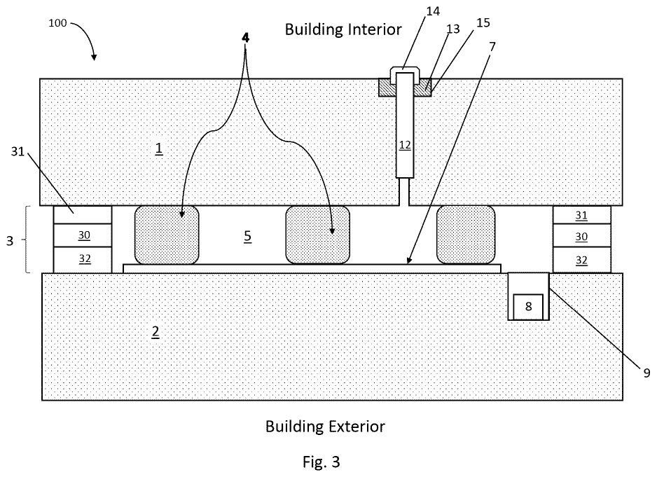

FIG. 3 is a side cross sectional view of a vacuum insulating unit/panel according to an example embodiment.

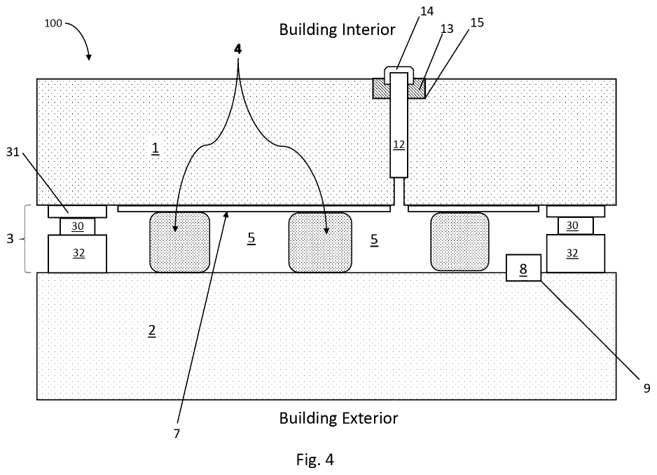

FIG. 4 is a side cross sectional view of a vacuum insulating unit/panel according to an example embodiment.

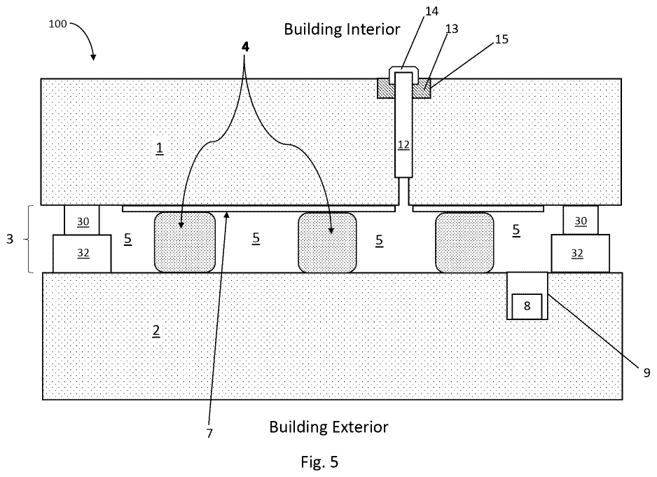

FIG. 5 is a side cross sectional view of a vacuum insulating unit/panel according to an example embodiment.

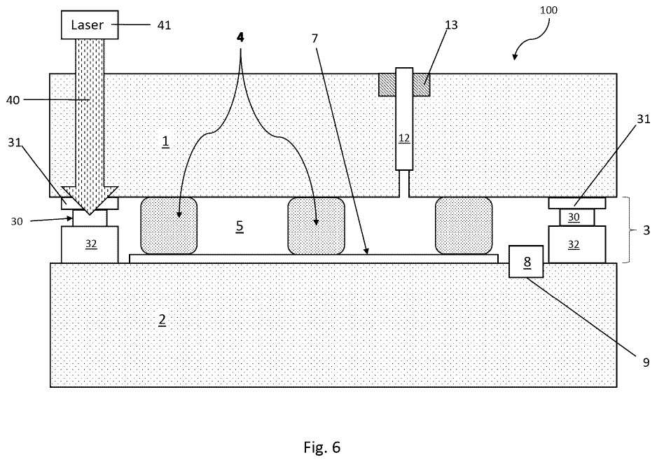

FIG. 6 is a side cross sectional schematic view of a vacuum insulating unit/panel according to an example embodiment, showing a laser being used in forming the edge seal during manufacturing, which may be used in combination with any embodiment herein including those of FIGS. 1-13.

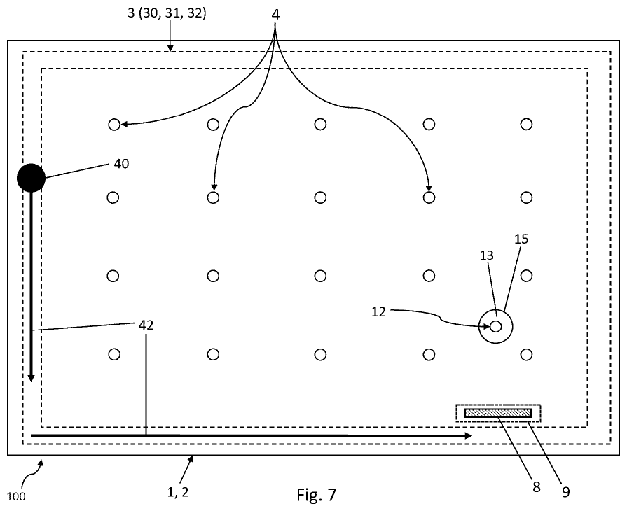

FIG. 7 is a schematic top view of a vacuum insulating unit/panel according to an example embodiment, showing a laser used in forming the edge seal during manufacturing, which may be used in combination with any embodiment herein including those of FIGS. 1-13.

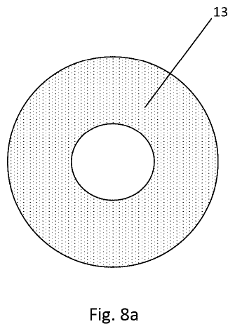

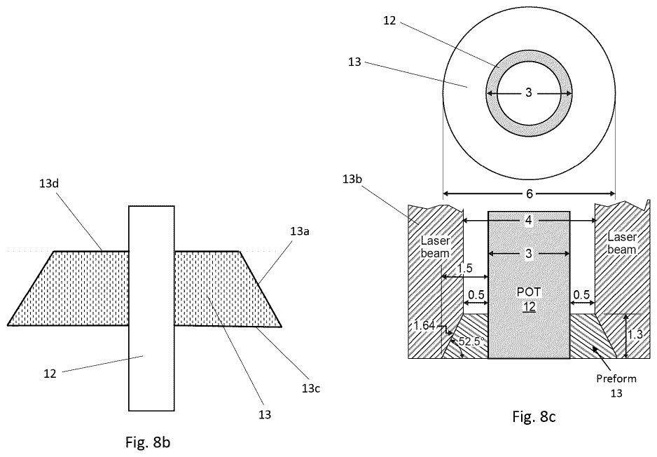

FIG. 8a is a top view of a ceramic preform to be used for a pump-out tube seal according to an example embodiment, which may be used in combination with any embodiment herein including those of FIGS. 1-13.

FIG. 8b is a cross-sectional view of a ceramic preform seal of FIG. 8a, surrounding a pump-out tube, according to an example embodiment, which may be used in combination with any embodiment herein including those of FIGS. 1-13.

FIG. 8c is a schematic cross-sectional diagram of the seal preform of FIGS. 8a-8b being laser sintered, according to an example embodiment, which may be used in combination with any embodiment herein including those of FIGS. 1-13.

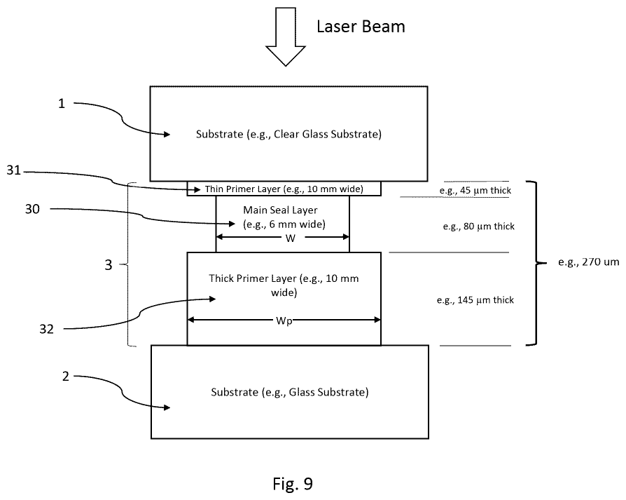

FIG. 9 is a side cross sectional view of an example edge seal for a vacuum insulating unit/panel according to an example embodiment, taken at the edge of a panel, with example layer thicknesses, which may be used in combination with any embodiment herein including those of FIGS. 1-13.

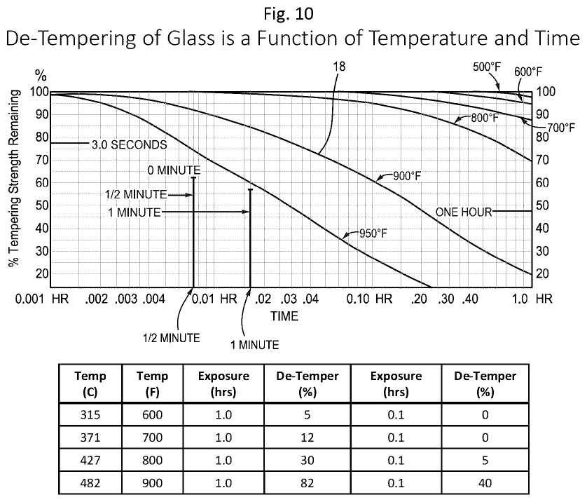

FIG. 10 is a % Tempering Strength Remaining vs. Time graph illustrating that de-tempering of glass is a function of temperature and time.

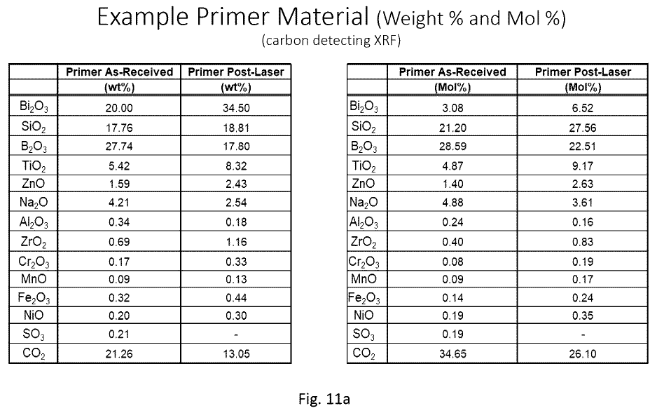

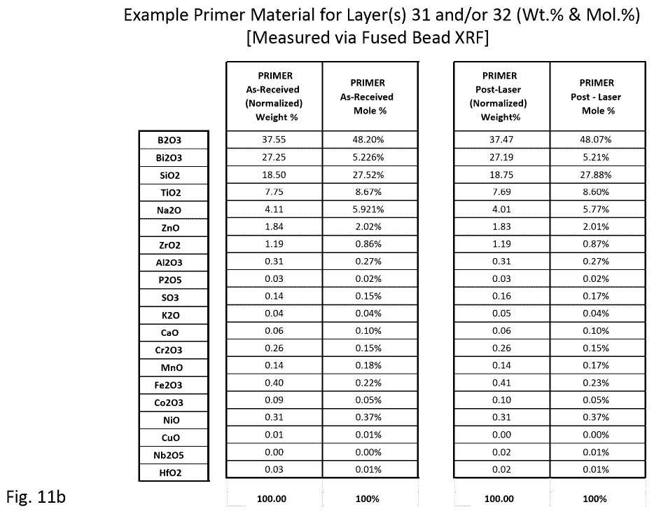

FIG. 11a is a table/graph showing weight % and mol % of various compounds/elements in a primer seal material according to an example embodiment (measured via carbon detecting XRF), before and after substrate tempering, which primer material may be used in combination with any embodiment herein (e.g., for one or both primer layers) including those of FIGS. 1-13.

FIG. 11b is a table/graph showing weight % and mol % of various compounds/elements in a primer seal material according to an example embodiment (measured via fused bead XRF), before and after substrate tempering, which primer material may be used in combination with any embodiment herein (e.g., for one or both primer layers) including those of FIGS. 1-13.

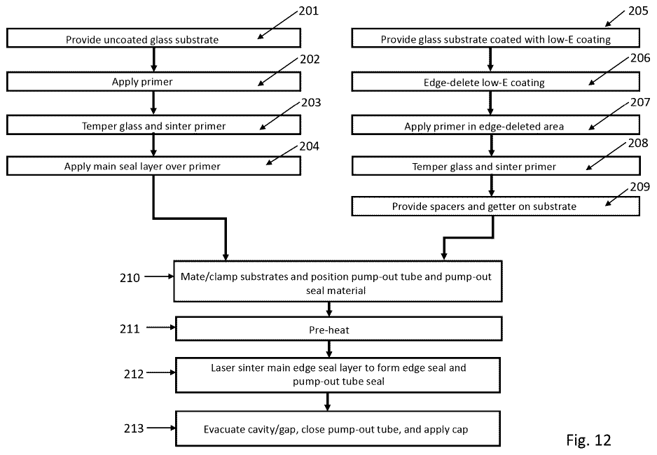

FIG. 12 is a flowchart illustrating example steps in making a vacuum insulating panel according to various example embodiments, which may be used in combination with any embodiment herein including those of FIGS. 1-11.

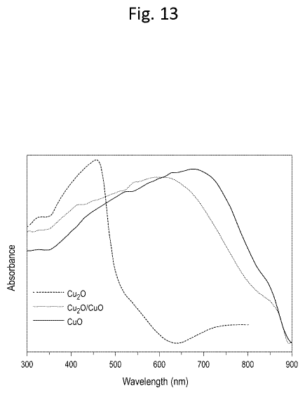

FIG. 13 is an absorption vs. wavelength (nm) graph illustrating absorbance at different wavelengths of various oxidation states of copper oxide.

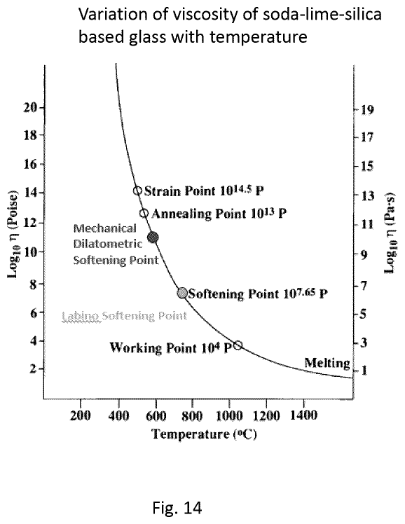

FIG. 14 is a graph illustrating variation of viscosity of conventional soda-lime-silica based glass, including Labino and Dilatometric softening points, based on temperature.

### DETAILED DESCRIPTION

The following detailed structural and/or functional description(s) is/are provided as examples only, and various alterations and modifications may be made. The example embodiments herein do not limit the disclosure and should be understood to include all changes, equivalents, and replacements within ideas and the technical scope herein. Hereinafter, certain examples will be described in detail with reference to the accompanying drawings. When describing various example embodiments with reference to the accompanying drawings, like reference numerals may refer to like components and a repeated description related thereto may be omitted.

FIGS. 1-5 are side cross sectional views each illustrating a vacuum insulating panel 100 according to various example embodiments, FIG. 6 is a side cross sectional view of an example vacuum insulating unit/panel 100 showing a laser used in sintering/firing the main seal layer 30 when forming the edge seal 3 during manufacturing (which may be used in combination with any embodiment herein), and FIG. 7 is a schematic top view of an example vacuum insulating unit/panel 100 showing a laser used in sintering/firing the main seal layer 30 when forming the edge seal 3 during manufacturing (which may be used in combination with any embodiment herein). It should be noted that, in practice, such vacuum insulating panels/units may be oriented upside down or sideways from the orientations illustrated in FIGS. 1-7. Vacuum insulating panel 100 may be used in window applications (e.g., for commercial and/or residential windows), and/or for other applications such as commercial refrigeration and consumer appliance applications.

Referring to FIGS. 1-7, each vacuum insulating panel 100 may include a first substrate 1 (e.g., glass substrate), a second substrate 2 (e.g., glass substrate), a hermetic edge seal 3 at least partially provided proximate the edge of the panel 100, and a plurality (e.g., an array) of spacers 4 provided between at least the substrates 1 and 2 for spacing the substrates from each other and so as to help provide low-pressure space/gap 5 between at least the substrates. Each glass substrate 1, 2 may be flat, or substantially flat, in certain example embodiments. Support spacers 4, sometimes referred to as pillars, may be of any suitable shape (e.g., round, oval, disc-shaped, square, rectangular, rod-shaped, etc.) and may be of or include any suitable material such as stainless steel, aluminum, ceramic, solder glass, metal, and/or glass. Certain example support spacers 4 shown in the figures are substantially circular as viewed from above and substantially rectangular as viewed in cross section, and may have rounded edges. The hermetic edge seal 3 may include one or more of main seal layer 30, upper primer layer 31, and lower primer layer 32. Each “layer” herein may comprise one or more layers. At least one thermal control and/or solar control coating 7, such as a multi-layer low-emittance (low-E) coating, may be provided on at least one of the substrates 1 and 2 in order to further improve insulating properties of the panel. The solar control coating 7 may be provided on substrate 1 or substrate 2, or such a solar control coating may be provided on both substrates 1 and 2. For example, FIGS. 1-3 and 6 illustrate such a coating 7 (e.g., low-E coating) provided on substrate 2, whereas FIGS. 4-5 illustrate the coating 7 provided on substrate 1. Each substrate 1 and 2 is preferably of or including glass, but may instead be of other material such as plastic or quartz. For example, one or both glass substrates 1 and 2 may be soda-lime-silica based glass substrates, borosilicate glass substrates, lithia aluminosilicate glass substrates, or the like, and may be clear or otherwise tinted/colored such as green, grey, bronze, or blue tinted. Substrates 1 and 2, in certain example embodiments, may each have a visible transmission of at least about 40%, more preferably of at least about 50%, and most preferably of from about 60-80%. The vacuum insulating panel 100, in certain example embodiments, may have a visible transmission of at least 40%, more preferably of at least 50%, and most preferably of at least 60%. The substrates 1 and 2 may be substantially parallel (parallel plus/minus ten degrees, more preferably plus/minus five degrees) to each other in certain example embodiments. Substrates 1 and 2 may or may not have the same thickness, and may or may not be of the same size and/or same material, in various example embodiments. When glass is used for substrates 1 and 2, each of the glass substrates may be from about 1-12 mm thick, more preferably from about 3-8 mm thick, and most preferably from about 4-6 mm thick. When glass is used for substrates 1 and 2, the glass may or may not be tempered (e.g., thermally tempered). Although thermally tempered glass substrates are desirable in certain environments, the glass substrate(s) may be heat strengthened in certain example embodiments. As known in the art, thermal tempering of glass typically involves heating the glass to a temperature of at least 585 degrees C., more preferably to at least 600 degrees C., more preferably to at least 620 degrees C. (e.g., to a temperature of from about 6209-650 degrees C.), and then rapidly cooling the heated glass so as to compress surface regions of the glass to make it stronger. The glass substrates may be thermally tempered to increase compressive surface stress and to impart safety glass properties including small fragmentation upon breakage. When tempered glass substrates 1 and/or 2 are used, the substrate(s) may be tempered (e.g., thermally or chemically tempered) prior to firing/sintering of main edge seal material 30 (e.g., via laser) to form the edge seal 3.

Heat strengthening of the glass substrates involves the same temperature ranges as tempering, but does not include the rapid cooling/quenching. When heat strengthened glass substrates 1 and/or 2 are used, the substrate(s) may be heat strengthened prior to firing/sintering of the main edge seal material 30 (e.g., via laser) to form the edge seal 3. When a vacuum insulated glass panel/unit has one tempered glass substrate and one heat strengthened substrate, the substrate(s) may be tempered (e.g., thermally or chemically tempered) and heat strengthened prior to firing/sintering of the main edge seal material 30 (e.g., via laser) to form the edge seal 3.

In various example embodiments, each vacuum insulating panel 100, still referring to FIGS. 1-7, optionally may also include at least one sorption getter 8 (e.g., at least one thin film getter) for helping to maintain the vacuum in low pressure space 5 by using reactive material for soaking up and/or bonding to gas molecules that remain in space 5, thus providing for sorption of gas molecules in low pressure space 5. The getter 8 may be provided directly on either glass substrate 1 or 2, or may be provided on a low-E coating 7 in certain example embodiments. In certain example embodiments, the getter 8 may be laser-activated and/or activated using inductive heating techniques, and/or may be positioned in a trough/recess 9 that may be formed in the supporting substrate (e.g., substrate 2) via laser etching, laser ablating, and/or mechanical drilling.

A vacuum insulating panel 100 may also include a pump-out tube 12 used for evacuating the space 5 to a pressure(s) less than atmospheric pressure, where the elongated pump-out tube 12 may be closed/sealed after evacuation of the space 5. Pump-out seal 13 may be provided around tube 12, and a cap 14 may be provided over the top of the tube 12 after it is sealed. Tube 12 may extend part way through the substrate 1, for example part way through a double countersink hole drilled in the substrate as shown in FIGS. 1-6. However, tube 12 may extend all the way through the substrate 1 in alternative example embodiments. Pump-out tube 12 may be of any suitable material, such as glass, metal, ceramic, or the like. In certain example embodiments, the pump-out tube 12 may be located on the side of the vacuum insulating panel 100 configured to face the interior of the building when the panel is used in a commercial and/or residential window. In certain example embodiments, the pump-out tube 12 may instead be located on the side of the vacuum insulating panel 100 configured to face the exterior of the building. The pump-out tube 12 may be provided in an aperture defined in either substrate 1 or 2 in various example embodiments. Pump-out seal 13 may be of any suitable material. In certain example embodiments, the pump-out seal 13 may be provided in the form of a substantially donut-shaped pre-form which may be positioned in a recess 15 formed in a surface of the substrate 1 or 2, so as to surround an upper portion of the tube 12, so that the pre-form can be laser treated/fired/sintered (e.g., after formation of the edge seal 3) to provide a seal around the pump-out tube 12. Alternatively, the pump-out seal 13 may be of any suitable material and/or may be dispensed in paste and/or liquid form to surround at least part of the tube 12 and may be sealed before and/or after evacuation of space 5. The pump-out seal material 13 may be directly applied to the glass substrate material or to a primer layer applied to the glass substrate surface prior to the pump-out seal material being applied to the substrate, in certain example embodiments. After evacuation of space 5, the tip of the tube 15 may be melted via laser to seal same, and hermetic sealing of the space 5 in the panel 100 can be provided both by the edge seal 3 and by the sealed upper portion of the pump-out tube 12 together with seal 13 and/or cap 14. In certain example embodiments, as shown in FIGS. 1-7 for example, the elongated pump-out tube 12 may be substantially perpendicular (perpendicular plus/minus ten degrees, more preferably plus/minus five degrees) to the substrates 1 and 2. Any of the elements/components shown in FIGS. 1-7 may be omitted in various example embodiments.

The evacuated gap/space 5 between the substrates 1 and 2, in the vacuum insulating panel 100, is at a pressure less than atmospheric pressure. For example, after the edge seal 3 has been formed, the cavity 5 evacuated to a pressure less than atmospheric pressure, and the pump-out tube 12 closed/sealed, the gap 5 between at least the substrates 1 and 2 may be at a pressure no greater than about 1.0×10⁻² Torr, more preferably no greater than about 1.0×10⁻³ Torr, more preferably no greater than about 1.0×10⁻⁴ Torr, and for example may be evacuated to a pressure no greater than about 1.0×10⁻⁶ Torr. The gap 5 may be at least partially filled with an inert gas in various example embodiments. In certain example embodiments, the evacuated vacuum gap/space 5 may have a thickness (in a direction perpendicular to planes of the substrates 1 and 2) of from about 100-1,000 μm, more preferably from about 200-500 μm, and most preferably from about 230-350 μm. Providing a vacuum in the gap/space 5 is advantageous as it reduces conduction and convection heat transport, so as to reduce temperature fluctuations inside buildings and the like, thereby reducing energy costs and needs to heat and/or cool buildings. Thus, panels 100 can provide high levels of thermal insulation.

Example low-emittance (low-E) coatings 7 which may be used in the vacuum insulating panel 100 are described in U.S. Pat. Nos. 5,935,702, 6,042,934, 6,322,881, 7,314,668, 7,342,716, 7,632,571, 7,858,193, 7,910,229, 8,951,617, 9,215,760, and 10,759,693, the disclosures of which are all hereby incorporated herein by reference in their entireties. Other low-E coatings may also, or instead, be used. A low-E coating 7 typically includes at least one IR reflecting layer (e.g., of or including silver, gold, or the like) sandwiched between at least first and second dielectric layer(s) of or including materials such as silicon nitride, zinc oxide, zinc stannate, and/or the like. A low-E coating 7 may have one or more of: (i) a hemispherical emissivity/emittance of no greater than about 0.20, more preferably no greater than about 0.04, more preferably no greater than about 0.028, and most preferably no greater than about 0.015, and/or (ii) a sheet resistance (Rₛ) of no greater than about 15 ohms/square, more preferably no greater than about 2 ohms/square, and most preferably no greater than about 0.7 ohms/square, so as to provide for solar control. In certain example embodiments, the low-E coating 7 may be provided on the interior surface of the glass substrate to be closest to the building exterior, which is considered surface two (e.g., see FIGS. 2-3), whereas in other example embodiments the low-E coating 7 may be provided on the interior surface of the glass substrate to be closest to the building interior, which is considered surface three (e.g., see FIGS. 4-5).

FIG. 1 illustrates an embodiment where the edge seal 3 is provided in the vacuum insulated glass panel 100 at the absolute edge, the seal layers 30, 31 and 32 all have substantially the same width (e.g., between about 6 mm and 12 mm), and a thickness of the main seal layer 30 is less than a thickness of primer layer 31 but greater than a thickness of the other primer layer 32. FIG. 2 illustrates an embodiment where the edge seal 3 is spaced inwardly from the absolute edge of the panel 100, the width of the main seal layer 30 is less than a width(s) of the primer layers 31 and 32, and a thickness of the main seal layer 30 is greater than a thickness of primer layer 31 but less than a thickness of the other primer layer 32. FIG. 3 illustrates an embodiment where the edge seal 3 is spaced inwardly from the absolute edge of the panel 100, the seal layers 30, 31 and 32 all have substantially the same width (e.g., between about 6 mm and 12 mm), and the seal layers 30, 31 and 32 all have substantially the same thickness. FIG. 4 illustrates an embodiment where the edge seal 3 is spaced inwardly from the absolute edge of the panel 100, the width of the main seal layer 30 is less than a width(s) of the primer layers 31 and 32, a thickness of the main seal layer 30 is greater than a thickness of primer layer 31 but less than a thickness of primer layer 32, and the low-E coating 7 is provided on substrate 1 (as opposed to the low-E coating being on substrate 2 in FIGS. 1-3). FIG. 5 illustrates an embodiment similar to FIG. 4, except that primer layer 31 is omitted in the FIG. 5 embodiment (note that primer layer 32 may also be omitted in certain example embodiments). FIG. 6 provides an example where a laser beam 40 from laser 41 is being used to heat the edge seal structure for sintering/firing the main seal layer 30 to form the hermetic edge seal 3, and FIG. 7 is a top view illustrating the laser beam 40 proceeding around the entire periphery of the panel along path 42 over the edge seal layers 30-32 to fire/sinter the main edge seal layer 30 in forming the hermetic edge seal 3. The laser beam 40 performs localized heating of the edge seal area, so as to not unduly heat certain other areas of the panel thereby reducing chances of significant de-tempering of the glass substrates. While heating for sintering the main seal layer 30 may be provided via laser in certain example embodiments, it is possible in alternative example embodiments to omit the laser and to instead sinter the seal material for the main seal layer 30 using an oven and/or furnace, localized IR heating, and/or the like. Each of these embodiments may be used in combination with any other embodiment described herein, in whole or in part.

Edge seal 3, which may include one or more of ceramic layers 30-32, may be located proximate the periphery or edge of the vacuum insulated panel 100 as shown in FIGS. 1-7. Edge seal 3 may be a ceramic edge seal in certain example embodiments. Referring to FIGS. 1-6, in certain example embodiments, layer 30 of the edge seal may be considered a main and/or primary seal layer, and layers 31 and 32 may be considered primer layers. One or more of seal layers 30-32, of the edge seal 3, may be of or include ceramic frit in certain example embodiments, and/or may be lead-free or substantially lead-free (e.g., no more than about 15 ppm Pb, more preferably no more than about 5 ppm Pb, even more preferably no more than about 2 ppm Pb) in certain example embodiments. In certain example embodiments, each primer layer 31 and 32 may be of a material having a coefficient of thermal expansion (CTE) that is between that of the main seal layer 30 and the closest glass substrate 1, 2. For example, referring to FIGS. 1-4, primer layers 31 and 32 may each have a CTE (e.g., from about 8.0 to 8.8×10⁻⁶ mm/(mm*deg. C), more preferably from about 8.3 to 8.6×10⁻⁶ mm/(mm*deg. C)) which is between a CTE (e.g., from about 8.7 to 9.3×10⁶ mm/(mm*deg. C), more preferably from about 8.8 to 9.2×10⁻⁶ mm/(mm*deg. C)) of the adjacent float glass substrate 1 and a CTE (e.g., from about 7.0 to 8.4×10⁻⁶ mm/(mm*deg. C), more preferably from about 7.2 to 8.2×10⁻⁶ mm/(mm*deg. C), more preferably from about 7.2 to 8.0×10⁻⁶ mm/(mm*deg. C), with an example being about 7.6×10⁻⁶ mm/(mm*deg. C)) of the main seal layer 30. The main seal layer 30 may have a CTE of at least 15% less than CTE(s) of the glass substrate(s) 1 and/or 2 in certain example embodiments. Thus, the multi-layer edge seal 3, via primer(s) 31 and/or 32, may provide for a graded CTE from the main seal 30 moving toward each glass substrate 1, 2, which provides for improved bonding of the edge seal to the glass and a more durable resulting vacuum insulating panel 100 such as capable of surviving exposure to asymmetric thermal loading and/or wind loads in the end application. The main seal layer 30, in certain example embodiments, may or may not contain significant amounts of CTE filler material. A primer(s) 31 and/or 32 may be omitted in certain example embodiments. In certain example embodiments, primer layers 31 and 32 may be of or include different material(s) compared to the main seal layer 30.

In certain example embodiments, before and/or after sintering/firing, one or both primer layer(s) 31 and/or 32 may have a melting point (Tm) higher than the melting point of the main seal layer 30. For example, in certain example embodiments, one or both primer layers 31 and/or 32 may have a melting point (Tm) of from about 500-750 degrees C. (more preferably from about 575-680 degrees C., and most preferably from about 600-650 degrees C.), whereas the main seal layer 30 may have a lower melting point (Tm) of from about 300 to 450 degrees C. (more preferably from about 350-430 degrees C., and most preferably from about 380-420 degrees C. or from about 390-410 degrees C.). In certain example embodiments, one or both of the primer layers 31 and/or 32 may have a melting point (Tm) at least 100 degrees C. higher, more preferably at least 150 degrees C. higher, and most preferably at least 200 degrees C. higher, than the melting point of the main seal material 30. For purposes of example, in an example embodiment the main seal layer 30 may have a melting point of from about 390-410 degrees C. or from about 390-395 degrees C., whereas the primer layers 31 and 32 may each have a melting point of from about 585-625 degrees C. or from about 610-625 degrees C. In certain example embodiments, before and/or after sintering/firing, one or both primer layer(s) 31 and/or 32 may have a transition point (Tg) higher than the transition point of the main seal layer 30. For example, in certain example embodiments, before and/or after sintering/firing, one or both primer layer(s) 31 and/or 32 may have a transition point of from about 400-600 degrees C. (more preferably from about 425-550 degrees C., and most preferably from about 450 to 510 degrees C.), whereas the main seal layer 30 may have a lower transition point of from about 200 to 350 degrees C. (more preferably from about 230-330 degrees C., and most preferably from about 260 to 310 degrees C.).

In a similar manner, in certain example embodiments, before and/or after sintering/firing, one or both primer layer(s) 31 and/or 32 may have a softening point (Ts) higher than the softening point of the main seal layer 30 (Labino and Dilatometric). For example, in certain example embodiments, one or both primer layer(s) 31 and/or 32 may have a Labino softening point of from about 425-650 degrees C. (more preferably from about 475-620 degrees C., and most preferably from about 520 to 590 degrees C.), whereas the main seal layer 30 may have a lower softening point of from about 220 to 410 degrees C. (more preferably from about 270-380 degrees C., more preferably from about 280-345 degrees C., more preferably from about 280 to 330 degrees C., more preferably from about 280 to 325 degrees C., and most preferably from about 280 to 320 degrees C.). Too high of a softening point for the seal material for layer 30 can lead to more heating and thus significant de-tempering of glass substrates during seal formation, whereas too low of a softening point for the seal material for layer 30 can lead to difficulties in removing binder from the material.

In certain example embodiments, before and/or after sintering/firing, one or both of the primer layer(s) 31 and/or 32 may have a Labino softening point (Ts) at least 100 degrees C. higher, more preferably at least about 150 degrees C. higher, and most preferably at least about 150 or 200 degrees C. higher, than the softening point (Ts) of the main seal layer material 30. For purposes of example, in an example embodiment the main seal layer 30 may have a Labino softening point of from about 300-325 degrees C., whereas the primer layers 31 and 32 may each have a softening point of from about 540-560 degrees C. For purposes of example, in an example embodiment the main seal layer 30 may have a melting point of from about 390-395 degrees C., whereas the primer layers 31 and 32 may each have a melting point of from about 610-625 degrees C. These feature(s) advantageously may allow each high melting point primer layers 31 and 32 to provide strong mechanical bonding with the supporting glass substrate (1 and/or 2) via sintering/firing in a first bulk heating step in an oven or other heater (e.g., heating above the melting point and/or softening point of the primer(s) while thermally tempering the glass substrate 1, 2 on which the primer is provided), and thereafter sintering/firing the lower melting point main seal material 30 in a different second heating step (e.g., via laser or other suitable manner) to bond the main seal layer 30 to the previously sintered/fired primers 31 and 32 and form the edge seal 3 without significantly de-tempering the glass substrates. Thus, the main seal layer 30 and primers 31 and 32 can be sintered/fired in different heating steps, in a manner which allows thermal tempering of the glass substrates 1 and 2 when sintering/heating the primers on the respective glass substrates, and which allows the main seal layer 30 to thereafter be sintered and bonded to the primers 31 and 32 without significantly de-tempering the glass substrates 1 and 2. This advantageously results in more efficient processing, reduction in damage (e.g., micro-cracking, adhesive failure, cohesive failure, and/or significant de-tempering), and a more durable and longer lasting vacuum insulating panel with much of its temper strength retained allowing for example compliance with industry safety testing for bag impact and/or point impact fragmentation.

The edge seal 3, in certain example embodiments, may be located at an edge-deleted area (where the solar control coating 7 has been removed) of the substrate as shown in FIGS. 1-6. Thus, the edge seal 3 may be positioned so that it does not overlap the low-E coating 7 in certain example embodiments. The edge seal 3 may be located at the absolute edge of the panel 100 (e.g., FIG. 1), or may be spaced inwardly from the absolute edge of the panel 100 as shown in FIGS. 2-7 and 9, in different example embodiments. An outer edge of the hermetic edge seal 3 may be located within about 50 mm, more preferably within about 25 mm, and more preferably within about 15 mm, of an outer edge of at least one of the substrates 1 and/or 2. Thus, an “edge” seal does not necessarily mean that the edge seal 3 is located at the absolute edge or absolute periphery of a substrate(s) or overall panel 100.

The low-E coating 7 may be edge deleted around the periphery of the entire unit so as to remove the low-e coating material from the coated glass substrate. The low-E coating 7 edge deletion width (edge of glass to edge of low-E coating 7), in certain example embodiments, in at least one area may be from about 0-100 mm, with examples being no greater than about 6 mm, no greater than about 10 mm, no greater than about 13 mm, no greater than about 25 mm, with an example being about 16 mm. In certain example embodiments, there may be a gap between the primer seal layers 31 and 32 and/or main layer 30, and the low-E coating 7, of at least about 0.5 mm, more preferably a gap of at least about 1.0 mm, and for example a gap of at least about 5 mm so that the low-E coating 7 is not contiguous with the main seal layer 30 and/or the primer seal layers 31 and 32.

In certain example embodiments and referring to FIGS. 1-7 and 9 for example, in the manufactured vacuum insulating panel 100, the main seal layer 30 of the edge seal 3 may have an average width W of from about 2-20 mm, more preferably from about 4-10 mm, more preferably from about 3-9 mm or from about 4-8 mm, still more preferably from about 5-7 mm, and with an example main seal layer 30 average width being about 6 mm; and/or one or both of the primer layers 31 and 32 may have an average width Wp of from about 2-20 mm, more preferably from about 6-14 mm, more preferably from about 8-12 mm, still more preferably from about 9-11 mm, and with an example primer average width being about 10 mm. In certain example embodiments, the respective width(s) of each layer 30, 31, and 32 may be substantially the same (the same plus/minus 10%, more preferably plus/minus 5%) along the length of the edge seal 3 around the periphery of the entire panel 100. In certain example embodiments, the ratio Wp/W of the width Wp of one or both primer layers 31, 32 to the width W of the main seal layer 30 may be from about 1.2 to 2.2, more preferably from about 1.4 to 1.9, and most preferably from about 1.5 to 1.8 (e.g., the ratio Wp/W is 1.67 when a primer layer 31 and/or 32 is 10 mm wide and the main seal layer 30 is 6 mm wide: 10/6=1.67). In certain example embodiments, one or both primer layers 31 and/or 32 may be at least about 1 mm wider, more preferably at least about 2 mm wider, and most preferably at least about 3 mm wider, than the main seal layer 30 at one or more locations around the periphery of the panel 100 and possibly around the entire periphery of the panel. These desirable widths for ceramic seal layers 30-32 in the panel 100 may be appropriate when using the materials for seal layers 30-32 discussed herein, and may be adjusted in an appropriate manner if different seal materials are instead used which is possible in certain example embodiments. Other widths for one or more of seal layers 30-32, not discussed herein, may be used in various other example embodiments.

In certain example embodiments, as viewed from above and/or in cross-section as shown in FIG. 9 for example, the lateral edge(s) 30a and/or 30b of the main seal layer 30 may be spaced inwardly an offset distance “D” from the respective lateral edges of the primer seal layer 31 and/or the primer seal layer 32 on each side of the main seal layer. In certain example embodiments, the offset distance “D” on one or both sides of the main seal layer 30 may be from about 0.5 to 6.0 mm, more preferably from about 0.5 to 3.0 mm, more preferably from about 0.5 to 2.5 mm, more preferably from about 1.0 to 2.5 mm, and most preferably from about 1.5 to 2.5 mm, with an example being about 2.0 mm on each side, although the offset distance “D” may be different on the left and right sides of the main seal layer as viewed in FIG. 9 for example. In certain example embodiments, the offset distance “D” on one or both sides of the main seal layer 30 may be at least about 0.5 mm, more preferably at least about 1.0 mm, and most preferably at least about 1.5 mm, as shown in FIG. 9 for example. See also FIGS. 2, 4 and 6.

In certain example embodiments and referring to FIGS. 1-7 and 9 for example, in the manufactured vacuum insulating panel 100, the main seal layer 30 of the edge seal 3 may have an average thickness of from about 30-120 μm, more preferably from about 40-100 μm, and most preferably from about 50-85 μm, with an example main seal layer 30 average thickness being from about 60-80 μm as shown in FIG. 9. In certain example embodiments, in the manufactured vacuum insulating panel 100, the primer layer 31 of the edge seal 3 may have an average thickness of from about 10-80 μm, more preferably from about 20-70 μm, and most preferably from about 20-55 μm, with an example primer layer 31 average thickness being about 45 μm as shown in FIG. 9. In certain example embodiments, in the manufactured vacuum insulating panel 100, the primer layer 32 (opposite the side from which the laser beam 40 is directed) of the edge seal 3 may have an average thickness of from about 100-220 μm, more preferably from about 120-200 μm, and most preferably from about 120-170 μm, with an example primer layer 32 average thickness being about 145 μm as shown in FIG. 9. In certain example embodiments, the thickness of the main seal layer 30 may be at least about 30 μm thinner (more preferably at least about 45 μm thinner) than the thickness of the primer seal layer 32, and may be at least about 10 μm thicker (more preferably at least about 20 μm, and more preferably at least about 30 μm thicker) than the thickness of the primer seal layer 31. In certain example embodiments, in the manufactured vacuum insulating panel 100, the overall average thickness of the edge seal 3 may be from about 150-330 μm, more preferably from about 200-310 μm, and most preferably from about 240-290 μm, with an example overall edge seal 3 average thickness being about 270 μm as shown in FIG. 9. In certain example embodiments, the respective thicknesses of each layer 30, 31, and 32 are substantially the same (the same plus/minus 10%, more preferably plus/minus 5%) along the length of the edge seal 3 around the periphery of the entire panel 100.

In certain example embodiments, in the manufactured vacuum insulating panel 100, the ratio T_{M}/T_{P1} of the thickness T_{M} of the main seal layer 30 to the thickness T_{P1} of thin primer layer 31 may be from about 1.2 to 2.2, more preferably from about 1.4 to 2.0, and most preferably from about 1.5 to 1.9 (e.g., the ratio T_{M}/T_{P1} is 1.78 when a primer layer 31 is 45 μm thick and the main seal layer 30 is 80 μm thick as shown in FIG. 9: 80/45=1.78). In certain example embodiments, in the manufactured vacuum insulating panel 100, the ratio T_{M}/T_{P2} of the thickness T_{M} of the main seal layer 30 to the thickness T_{P2} of the primer layer 32 may be from about 0.25 to 0.90, more preferably from about 0.40 to 0.75, and most preferably from about 0.45 to 0.65 (e.g., the ratio T_{M}/T_{P2} is 0.55 when a primer layer 32 is 145 μm thick and the main seal layer 30 is 80 μm thick as shown in FIG. 9: 80/145=0.55). In certain example embodiments, in the manufactured vacuum insulating panel 100, the ratio T_{M}/Tₛ of the thickness T_{M} of the main seal layer 30 to the total thickness Tₛ of the overall edge seal 3 may be from about 0.15 to 0.60, more preferably from about 0.20 to 0.50, and most preferably from about 0.25 to 0.35 (e.g., the ratio T_{M}/Tₛ is 0.30 when the overall seal 3 is 270 μm thick and the main seal layer 30 is 80 μm thick as shown in FIG. 9: 80/270=0.30). These thicknesses for ceramic seal layers 30-32 in the panel 100 may be appropriate when using the materials for seal layers 30-32 discussed herein, and may be adjusted in an appropriate manner such as if different seal materials are instead used which is possible in certain example embodiments. Other thicknesses for layers 30-32, not discussed herein, may be used in various other example embodiments.

In various example embodiments, laser 41 may be selected to emit a laser beam 40 having a wavelength (λ) of from about 500 nm to 1064 nm, more preferably from about 780-1064 nm. Laser 41 may be a near IR laser in certain example embodiments. Laser 41 may be a continuous wave laser, a pulsed laser, and/or other suitable laser in various example embodiments. In various example embodiments, the laser 41 may be a scanning laser system comprising diode, ND: YAG, CO₂ and/or other laser devices/sources. In certain example embodiments, laser 41 may emit a laser beam 40 at or having a wavelength of about 532 nm, 546 nm, 564 nm, 800 nm, 808 nm, 810 nm, 940 nm, or 1090 nm (e.g., YVO4 laser). In certain example embodiments, more than one laser may be utilized to increase the sealing speed, lower effective laser power levels and/or reduce laser spot size. Two lasers operating in a serial, overlapping manner can increase the effective irradiation spot time to achieve for example 0.5 seconds while achieving for example a 20 mm per second linear laser rate, as an example. Two 9-mm laser diameter beams 40, for example, can operate in a serial fashion for a 0.5 second to 1.0 second irradiation time.

FIGS. 11a-11b illustrate an example material(s) that may be used for one or both primer layer(s) 31 and/or 32 in certain example embodiments. FIG. 11a is a table/graph showing weight % and mol % of various compounds/elements in a primer seal material according to an example embodiment (measured via carbon detecting XRF/XPSYU), before and after substrate tempering, which primer material may be used in combination with any embodiment herein (e.g., for one or both primer layers 31 and/or 32) including those of FIGS. 1-13. FIG. 11b is a table/graph showing weight % and mol % of various compounds/elements in a primer seal material according to an example embodiment (measured via fused bead XRF/XPS), before and after substrate tempering, which primer material may be used in combination with any embodiment herein (e.g., for one or both primer layers 31 and/or 32) including those of FIGS. 1-13. In certain example embodiments, the primer layer(s) 31 and/or 32 are formed prior to the main seal layer 30, such as during tempering of heat strengthening of the corresponding glass substrates 1, 2.

U.S. Patent Documents 2024/0167320 and 2024/0167324 provide example descriptions of making a vacuum insulated panel which includes a tellurium oxide-based seal layer and optional primer(s) 31 and/or 32, the disclosures of which are hereby incorporated herein by reference in their entireties.

After primer layer(s) 31 and/or 32 is/are formed, the main seal layer 30 is to be formed. Material to be used to form the main seal layer 30 may be in the form of a paste which is applied to one or both glass substrate over the fired primer, where the paste for layer 30 includes glass (made up of one or more glasses), optional filler material (e.g., cordierite, beta eucryptite/eucryptite, zirconyl phosphates, dizirconium diorthophosphate, aluminum phosphate, amorphous or substantially amorphous silica, amorphous or substantially amorphous borosilicate glass, amorphous or substantially amorphous lithia aluminosilicate glass, mullite, magnesium alumino silicate glass, zinc alumino silicate glass, or zircon, alone or in combination), a binder (e.g., polypropylene carbonate), and a solvent, with the resulting composite/paste being applied and fired/sintered to form seal layer 30 of the vacuum insulating panel 100. Heat is used to remove the solvent and binder from the paste, and to fire/sinter remaining seal material in order to form the seal layer 30. Herein, in the paste prior to firing/sintering, the filler is considered distinct from the glass portion of the paste. Thus, any description of glass (e.g., of the paste) to be heated to form the seal layer 30 is irrespective of, and distinct from, any optional filler material which may also be included in the paste in addition to the glass.

As explained above, large amounts of ZnO and Al₂O₃ in the glass of the paste to be used in forming main seal layer 30 can lead to an elevated softening point of that glass. The presence of aluminum oxide and zinc oxide in the pre-sintering glass raises the softening point and thus the firing temperature of the glass. The higher the softening point of the glass in the paste, the more heating and/or higher temperatures needed for firing during seal formation and thus the more de-tempering of glass substrate(s) 1 and/or 2 which may occur during firing/sintering of the seal-forming process for layer 30. Aluminum oxide and zinc oxide also have significant solubility from glass into alkaline solutions, thereby leading to suspect alkaline durability in certain situations. Thus, it has been found that such large amounts of ZnO and Al₂O₃ in the glass of that paste may be undesirable in certain situations.

In certain example embodiments, the pre-sintering glass, exclusive of any filler, of the paste for use in forming main seal layer 30 in a vacuum insulated panel 100 may include tellurium oxide (e.g., TeO₂, TeO₃, TeO₄, other suitable stoichiometry, and/or combinations thereof) and may be designed to have little or no aluminum oxide (e.g., Al₂O₃ or other suitable stoichiometry) and little or no zinc oxide (e.g., ZnO or other suitable stoichiometry). Tellurium oxide helps lower the melting point and softening point of the seal material. For example, tellurium oxide may be the largest metal oxide component, in terms of magnitude with respect to wt. % and/or mol %, in the pre-sintering glass in certain example embodiments. Vanadium oxide may also be provided in this pre-sintering glass. In certain example embodiments, this pre-sintering glass may comprise from about 0-4% (more preferably from about 0-3%, more preferably from about 0-2%, more preferably from about 0-1%, and most preferably from about 0-0.5%) aluminum oxide; and/or from about 0-10% or 0-4% (more preferably from about 0-3%, more preferably from about 0-2%, more preferably from about 0-1%, and most preferably from about 0-0.5%) zinc oxide, in terms of wt. % and/or mol %. Advantageously, little or no aluminum oxide and zinc oxide in this pre-sintering glass allows the pre-sintering glass to realize a combination of reasonable flow and a lower softening point, which can lead to less heating being needed for firing/sintering (e.g., a lower firing/sintering temperature) and thus less de-tempering of glass substrate(s) 1 and/or 2 of the panel during heating (e.g., laser and/or otherwise) involved in forming seal layer 30. Also, little or no aluminum oxide and zinc oxide in this glass (e.g., the glass powder in a paste for instance) may allow the resulting edge seal 3 to realize improved alkaline durability.

In certain example embodiments, the pre-sintering glass, exclusive of any filler, of the paste for use in forming main seal layer 30 may also include at least one of: copper oxide, bismuth oxide, titanium oxide, lanthanum oxide, yttrium oxide, manganese oxide, boron oxide, and/or any combination thereof.

For example, a thermal diffusivity/conductivity additive such as metallic copper or copper oxide (e.g., CuOₓ, where x may be from about 0.2 to 1.5, more preferably from about 0.5 to 1.4, more preferably from about 0.8 to 1.2, more preferably from about 0.9 to 1.1, with an example being about 1.0) may be provided in glass of the paste to be used for forming seal layer 30 in order to increase thermal diffusivity and/or absorption of the main seal material so that it can be sintered more quickly and/or more efficiently in the manufacturing process. Copper oxide can also help stabilize the glass and increase flow thereof.

Bismuth oxide (e.g., Bi₂O₃ and/or other stoichiometry) and/or titanium oxide (e.g., TiO₂ and/or other stoichiometry) may be provided in glass of the paste to be used for forming seal layer 30 in order to improve the bonding of seal layer 30 to primer layer(s) 31 and/or 32, and/or to improve seal durability.

Lanthanum oxide (e.g., La₂O₃ and/or other stoichiometry) and yttrium oxide (e.g., Y₂O₃ and/or other stoichiometry) may be provided in glass of the paste to be used for forming seal layer 30 in order to improve the alkaline durability of the seal.

Manganese oxide (e.g., MnO or other stoichiometry) may be provided in glass of the paste to be used for forming seal layer 30 in order to improve bonding to primer(s) seal layer 31 and/or 32, stabilize the glass and/or increase flow thereof.

Boron oxide (e.g., B₂O₃ and/or other stoichiometry) may be provided in glass of the paste to be used for forming seal layer 30 in order to lower the softening point and thus the firing temperature of the glass, and thus reduce de-tempering.

Table 1A below sets forth example ranges for various elements and/or compounds for glass configured to be used in a paste for forming seal layer 30, for both mol % and weight %, prior to firing/sintering thereof and thus prior to layer 30 formation. It will be appreciated that other materials may be used together, or in place of, those shown below, and that the example percentages may be different in alternate embodiments. The ranges in Table 1A are irrespective of any filler material or other materials which may be used in the paste.

TABLE 1A
(example glass, to be used in a paste for forming seal layer 30, prior to firing/sintering)

| | | More | Most | | More | Most |
|---|---|---|---|---|---|---|
| | General | Preferred | Preferred | General | Preferred | Preferred |
| | (Mol %) | (Mol %) | (Mol %) | (Wt. %) | (Wt. %) | (Wt. %) |
| Tellurium oxide | 10-80% or | 35-70% or | 45-65% | 20-75% | 30-70% | 40-60% |
| (e.g., TeO₄ and/or | 20-75% | 40-70% | | | | |
| other stoichiometry) | | | | | | |
| Vanadium oxide | 5-45% or | 10-45% or | 25-35% | 5-50% | 15-45% | 25-40% |
| (e.g., VO₂ and/or | 5-58% | 20-40% | | | | |
| other stoichiometry) | | | | | | |
| Aluminum oxide | 0-4% or | 0-2% or | 0-0.5% | 0-5% or | 0-4% | 0-1% |
| (e.g., Al₂O₃ and/or | 0-3% | 0-1% | | 1-4% | | |
| other stoichiometry) | | | | | | |
| Zinc oxide (e.g., | 0-10% or | 0-2% or | 0-0.5% | 0-10% | 0-4% | 0-1% |
| ZnO and/or other | 0-4% | 0-1% | | | | |
| stoichiometry) | | | | | | |
| Phosphorous oxide | 0-4% or | 0-2% or | 0-0.5% | 0-4% | 0-1% | 0-1% |
| (e.g., P₂O₅ and/or | 0-3% | 0-1% | | | | |
| other stoichiometry) | | | | | | |
| Tungsten oxide | 0-4% or | 0-2% or | 0-0.5% | 0-4% | 0-1% | 0-1% |
| (e.g., WO₃ and/or | 0-3% | 0-1% | | | | |
| other stoichiometry) | | | | | | |
| Molybdenum oxide | 0-4% or | 0-2% or | 0-0.5% | 0-4% | 0-1% | 0-1% |
| (e.g., MoO₃ and/or | 0-3% | 0-1% | | | | |
| other stoichiometry) | | | | | | |
| Copper oxide (e.g., | 0-40% or | 1-25% or | 4-22% or | 0-25% or | 3-20% | 7-15% or |
| CuO or other | 0.5-40% | 4-25% or | 5-15% | 1-25% | | 9-13% |
| stoichiometry) | | 5-22% | | | | |
| Bismuth oxide (e.g., | 0-40% or | 1-25% or | 0-1.0% or | 0-45% or | 15-40% or | 0-1.0% or |
| Bi₂O₃ and/or other | 0.5-30% | 3-22% or | 0-0.5% | 1-45% | 20-35% or | 0-0.5% |
| stoichiometry) | | 0-3% | | | 0-3% | |
| Titanium oxide | 0-30% or | 1-25%, 3-25%, | 1-5% or | 0-20% or | 0.5-10% or | 1-3% |
| (e.g., TiO₂ and/or | 0.5-30% | 3-20%, or | 2-4% or | 1-15% | 1-5% | |
| other stoichiometry) | | 3-15%, or | 0-3% | | | |
| | | 1-8% | | | | |
| Lanthanum oxide | 0-40% or | 1-25% or | 5-20%, | 0-45% or | 15-40% or | 22-30% |
| (e.g., La₂O₃ and/or | 1-30% | 3-25% | 6-15% or | 1-45% | 20-35% | |
| other stoichiometry) | | | 0-3% | | | |
| Yttrium oxide (e.g., | 0-30% or | 1-15% | 3-10% or | 0-35% or | 3-30% or | 5-15% |
| Y₂O₃ and/or other | 1-20% | or | 4-8% or | 1-35% | 5-25% | |
| stoichiometry) | | 3-15% | 0-3% | | | |
| Manganese oxide | 0-40% or | 1-25% | 5-22% or | 0-40% or | 1-25% | 1-22% or |
| (e.g., MnO and/or | 1-40% | | 5-15% or | 1-40% | | 2-8% |
| other stoichiometry) | | | 0-5% | | | |
| Boron oxide (e.g., | 0-40% or | 1-15% or | 6-20% or | 0-15% or | 1-10% | 1-5% |
| B₂O₃ and/or other | 0-20% | 3-15% | 5-10% or | 1-15% | | |
| stoichiometry) | | | 0-3% | | | |

Certain other oxides such as ZrO₂, Nb₂O₅ and/or iron oxide may also be provided in the glass, for example in a range of from about 0-20 wt. %.

After the glass outlined in Table 1A is heated (e.g., via laser and/or otherwise) to form seal layer 30 of seal 3, the resulting seal layer 30 in the panel 100 may contain the same or similar ranges of tellurium oxide, vanadium oxide, copper oxide, lanthanum oxide, bismuth oxide, boron oxide, titanium oxide, yttrium oxide, and manganese oxide mentioned above in Table 1A.

In certain example embodiments, the glass may be designed to contain little or no tungsten oxide (e.g., WO₃ or other stoichiometry), molybdenum oxide (e.g., MoO₃ or other stoichiometry) and/or phosphorous oxide (e.g., P₂O₅), as these may degrade chemical durability in vacuum insulating panel window applications.

Various example glasses were made, melted, and softening point measured, according to various example embodiments. Example glasses to be used for forming seal layer 30 (e.g., to be part of the paste applied to a glass substrate), according to various examples that were made, melted and tested, are as follows in terms of mol % of the glass:

TABLE 1B
EXAMPLE GLASSES (prior to firing/sintering) [mol %]

| | Comparative | | | | | | |
|---|---|---|---|---|---|---|---|
| | Example | Ex. 1 | Ex. 2 | Ex. 3 | Ex. 4 | Ex. 5 | Ex. 6 |
| Tellurium oxide | 54.4% | 60% | 60.5% | 54.5% | 50% | 50% | 52.5% |
| Vanadium oxide | 27.3% | 40% | 33.5% | 33.5% | 30% | 30% | 30% |
| Aluminum oxide | 18.3% | 0% | 0% | 0% | 0% | 0% | 0% |
| Copper oxide | 0% | 0% | 0% | 0% | 20% | 0% | 0% |
| Bismuth oxide | 0% | 0% | 6% | 12% | 0% | 0% | 7% |
| Titanium oxide | 0% | 0% | 0% | 0% | 0% | 0% | 3.5% |
| Manganese oxide | 0% | 0% | 0% | 0% | 0% | 20% | 0% |
| Boron oxide | 0% | 0% | 0% | 0% | 0% | 0% | 7% |
| Labino | 334° C. | 292° C. | 304° C. | 325° C. | 323° C. | 324° C. | 326° C. |
| Softening Point | | | | | | | |
| (Ts) (Deg. C.) | | | | | | | |
| Dilatometric | 300° C. | 264° C. | 273° C. | 288° C. | 294° C. | 298° C. | 287° C. |
| Softening Point | | | | | | | |
| (Ts) (Deg. C.) | | | | | | | |

| | Ex. 7 | Ex. 8 | Ex. 9 | Ex. 10 | Ex. 11 | Ex. 12 | Ex. 13 | Ex. 14 |
|---|---|---|---|---|---|---|---|---|
| Tellurium | 58.85% | 59.83% | 62.45% | 59.83% | 54.40% | 59.0% | 68.6% | 54.4% |
| oxide (e.g., | | | | | | | | |
| TeO₄, TeO₃, | | | | | | | | |
| or any other | | | | | | | | |
| suitable | | | | | | | | |
| stoichiometry) | | | | | | | | |
| Vanadium | 9.42% | 29.91% | 31.23% | 29.91% | 27.20% | 32.0% | 20.0% | 27.2% |
| oxide (e.g., | | | | | | | | |
| V₂O₅, VO₂, or | | | | | | | | |
| any other | | | | | | | | |
| suitable | | | | | | | | |
| stoichiometry) | | | | | | | | |
| Bismuth | 7.73% | 6.26% | 2.32% | 4.90% | 9.40% | 0% | 0.40% | 14.4% |
| oxide (e.g., | | | | | | | | |
| Bi₂O₃ or any | | | | | | | | |
| other suitable | | | | | | | | |
| stoichiometry) | | | | | | | | |
| Aluminum | 4% | 4% | 4% | 4% | 4% | 4% | 1.0% | 4% |
| oxide (e.g., | | | | | | | | |
| Al₂O₃ or any | | | | | | | | |
| other suitable | | | | | | | | |
| stoichiometry) | | | | | | | | |
| Titanium | 0% | 0% | 0% | 1.36% | 5.0% | 0% | 0% | 0% |
| oxide (e.g., | | | | | | | | |
| TiO₂ and/or | | | | | | | | |
| other | | | | | | | | |
| stoichiometry) | | | | | | | | |
| Zinc oxide | 0% | 0% | 0% | 0% | 0% | 5.0% | 10.0% | 0% |
| (e.g., ZnO | | | | | | | | |
| and/or other | | | | | | | | |
| stoichiometry) | | | | | | | | |
| Labino | 319° C. | 314° C. | 314° C. | 315° C. | 343° C. | 317° C. | 328° C. | 341° C. |
| Softening Point | | | | | | | | |
| (Ts) (Deg. C.) | | | | | | | | |
| Dilatometric | | | | | 314° C. | 285° C. | 295° C. | 313° C. |
| Softening Point | | | | | | | | |
| (Ts) (Deg. C.) | | | | | | | | |

Table 1B above provides data for the example glasses in terms of mol %. Meanwhile, Table 1C below provides data for the same example glasses in terms of weight %.

TABLE 1C
EXAMPLE GLASSES (prior to firing/sintering) [wt. %]

| | Comparative | | | | | | |
|---|---|---|---|---|---|---|---|
| | Example | Ex. 1 | Ex. 2 | Ex. 3 | Ex. 4 | Ex. 5 | Ex. 6 |
| Tellurium oxide | 56% | 56.83% | 52.07% | 42.68% | 53.11% | 52.59% | 46.9% |
| Vanadium oxide | 32% | 43.17% | 32.85% | 29.89% | 36.3% | 35.95% | 30.54% |
| Aluminum oxide | 12% | 0% | 0% | 0% | 0% | 0% | 0% |
| Copper oxide | 0% | 0% | 0% | 0% | 10.59% | 0% | 0% |
| Bismuth oxide | 0% | 0% | 15.08% | 27.43% | 0% | 0% | 18.26% |
| Titanium oxide | 0% | 0% | 0% | 0% | 0% | 0% | 1.57% |
| Manganese oxide | 0% | 0% | 0% | 0% | 0% | 11.46% | 0% |
| Boron oxide | 0% | 0% | 0% | 0% | 0% | 0% | 2.73% |
| Softening Point | 334° C. | 292° C. | 304° C. | 325° C. | 323° C. | 324° C. | 326° C. |
| (Ts) (Deg. C.) | | | | | | | |
| Dilatometric | 300° C. | 264° C. | 273° C. | 288° C. | 294° C. | 298° C. | 287° C. |
| Softening Point | | | | | | | |
| (Ts) (Deg. C.) | | | | | | | |

| | Ex. 7 | Ex. 8 | Ex. 9 | Ex. 10 | Ex. 11 | Ex. 12 | Ex. 13 | Ex. 14 |
|---|---|---|---|---|---|---|---|---|
| Tellurium | 49.0% | 50.99% | 57.39% | 53.68% | 46.14% | 58.67% | 70.50% | 41.85% |
| oxide (e.g., | | | | | | | | |
| TeO₄, TeO₃, | | | | | | | | |
| or any other | | | | | | | | |
| suitable | | | | | | | | |
| stoichiometry) | | | | | | | | |
| Vanadium | 27.92% | 29.05% | 32.70% | 30.58% | 26.29% | 36.26% | 23.42% | 23.84% |
| oxide (e.g., | | | | | | | | |
| V₂O₅, VO₂, or | | | | | | | | |
| any other | | | | | | | | |
| suitable | | | | | | | | |
| stoichiometry) | | | | | | | | |
| Bismuth | 20.93% | 17.76% | 7.54% | 12.84% | 23.28% | 7.55% | 0.18% | 32.34% |
| oxide (e.g., | | | | | | | | |
| Bi₂O₃ or any | | | | | | | | |
| other suitable | | | | | | | | |
| stoichiometry) | | | | | | | | |
| Aluminum | 2.15% | 2.20% | 2.36% | 2.29% | 2.17% | 2.36% | 0.66% | 1.97% |
| oxide (e.g., | | | | | | | | |
| Al₂O₃ or any | | | | | | | | |
| other suitable | | | | | | | | |
| stoichiometry) | | | | | | | | |
| Titanium | 0% | 0% | 0% | 0.61% | 2.12% | 0% | 0% | 0% |
| oxide (e.g., | | | | | | | | |
| TiO₂ and/or | | | | | | | | |
| other | | | | | | | | |
| stoichiometry) | | | | | | | | |
| Zinc oxide | 0% | 0% | 0% | 0% | 0% | 2.53% | 5.24% | 0% |
| (e.g., ZnO | | | | | | | | |
| and/or other | | | | | | | | |
| stoichiometry) | | | | | | | | |
| Labino | 319° C. | 314° C. | 314° C. | 315° C. | 343° C. | 317° C. | 328° C. | 341° C. |
| Softening Point | | | | | | | | |
| (Ts) (Deg. C.) | | | | | | | | |
| Dilatometric | | | | | 314° C. | 285° C. | 295° C. | 313° C. |
| Softening Point | | | | | | | | |
| (Ts) (Deg. C.) | | | | | | | | |

It can be seen from the above data that the Comparative Example glass, with includes 18.26 mol % aluminum oxide, had a rather high Labino softening point of 330 degrees C. For example, comparing the Example 1 (as well as other examples 1-6) to the Comparative Example, it can be seen that removing the aluminum oxide essentially lowered the softening point (and thus relatively the firing temperature) of the glass down to 292 degrees C. in Example 1. Certain other examples, without aluminum oxide, had a softening point lower than the Comparative Example. Thus, the data makes clear that the presence of aluminum oxide increases the softening point of the glass. Moreover, it can be seen from the data above that adding bismuth oxide, while improving durability, increases the softening point of the glass. Bismuth oxide can be advantageous in that it can increase density and thus sealing performance of the resulting seal layer. Thus, when it is desirable to have a relatively low Labino softening point, it is desirable to omit bismuth oxide form the glass or keep it at small amounts. Thus, in certain example embodiments, the glass may be substantially free (no more than about 1%, more preferably no more than about 0.5%, wt. % or mol %) of and/or free of bismuth oxide, in order to reduce Labino softening points for example.

In certain example embodiments, the glass may be designed to have a Labino softening point of less than 345 degrees C., more preferably less than 335 degrees C., more preferably less than 330 degrees C., more preferably from about 250-325 degrees C., more preferably from about 270-325 degrees C., more preferably from about 280-325 degrees C., more preferably from about 280-320 degrees C., and most preferably from about 280-310 degrees C.

The tables above regarding the example glasses list both Labino and Dilatometric softening points. Dilatometric softening point is the most common technique for measuring softening point. Softening points may be measured via both techniques. However, it has been found that in the manufacture of vacuum insulated glass panels a significant driver is the Labino Softening Point because it better defines physical flow properties of the glass especially under clamped force which is used in the vacuum insulated panel manufacturing process, and thus allows the glass to be designed to allow for reduced de-tempering of glass substrates 1 and 2 during seal layer formation. A low Labino softening point for the glass, before and/or after seal formation, is desirable because it leads to less de-tempering of glass substrates 1 and 2 during formation of seal layer 30. In an example vacuum insulated panel manufacturing process (e.g., see FIG. 12 and description thereof), the glass substrates 1 and 2 may be clamped together, via clamps such as using a 10-20 pounds per linear inch of force, when the seal layer 30 is being formed. Glasses herein may be optimized for both Labino and Dilatometric softening points for vacuum insulated panel manufacturing, which is difficult because the slopes of the curves for Labino and Dilatometric softening points are not linear between compositions. Regarding differences between Labino and Dilatometric, see for example FIG. 14 where the Labino softening point is significantly higher than is the dilatometric softening point for soda-lime-silica based glass for purposes of example.

Liquefaction is a process that generates a liquid from a solid or gas, or which generates a non-liquid phase which behaves in accordance with fluid dynamics. The glasses here have been designed so that liquefaction can be used to take the seal glass inclusive paste with binder substantially or fully removed, heat it to or above the softening point and then the working point, and optionally then the melting point, when the glass substrates 1 and 2 are clamped together around the seal material, in order to deform the seal glass material to form seal layer 30 in desired dimensions. FIG. 14 illustrates that, for example with soda-lime-silica based glass, the Labino softening point is closer to the working point than is the Dilatometric softening point, and thus more important for vacuum insulating panel manufacturing. Glasses here have optimized the Labino softening point and the working point to allow optimal flow with applied clamping pressure.

In certain example embodiments, it has been found that a ratio LSPT/DSPT of the Labino softening point (LSPT) to the Dilatometric softening point (DSPT), in degrees C., from about 1.05 to 1.45, more preferably from about 1.05 to 1.40, more preferably from about 1.05 to 1.25, more preferably from about 1.05 to 1.20, more preferably from about 1.108 to 1.17, and most preferably from about 1.10 to 1.15, is desirable in that it allows for sufficient flowability of the seal material glass while clamped, helps optimize liquefaction, and reduces de-tempering of glass substrates 1 and 2, during formation of seal layer 30.

Tellurium Vanadate based and/or inclusive glasses (including tellurium oxide and vanadium oxide), such as those in Table 1, in certain example embodiments are ideally suited for the main seal functionality when utilizing laser irradiation for the firing/sintering of the main seal layer 30. The glass in the paste may comprise tellurium oxide (e.g., a combination of TeO₃, TeO₃₊₁, and TeO₄) and vanadium oxide (e.g., a combination of V₂O₅, VO₂, and V₂O₃), and/or one or more of the other components mentioned herein. In certain example embodiments, it may be desirable to have a higher amount of tellurium oxide compared to vanadium oxide, in order to increase the material density in the sintered state and thus improve hermiticity of the seal. Tellurium oxide and vanadium oxide in the glass of the paste may be made up of about the following stoichiometries before firing/sintering as shown below in Table 2 (tellurium oxide stoichiometries prior to firing/sintering), and Table 3 (vanadium oxide stoichiometries prior to firing/sintering), as indicated by XPS measurements.

TABLE 2
(example stoichiometries of Te oxide in glass for
main seal layer 30 prior to firing/sintering)

| | | More | Most | |
|---|---|---|---|---|
| | General | Preferred | Preferred | Example |
| TeO₄ | 35-85% | 45-70% | 55-60% | 57% |
| TeO₃ | 20-65% | 30-55% | 35-45% | 42% |
| TeO₃₊₁ | 0-15% | 0.2-7% | 0.5-3% | 1% |

TABLE 3
(example stoichiometries of V oxide in glass for
main seal layer 30 prior to firing/sintering)

| | | More | Most | |
|---|---|---|---|---|
| | General | Preferred | Preferred | Example |
| V₂O₅ | 50-97% | 70-95% | 80-90% | 84% |
| VO₂ | 5-35% | 10-20% | 12-18% | 15% |
| V₂O₃ | 0-15% | 0.2-7% | 0.5-3% | 1% |

For example, the “Example” column in Table 2 indicates that 57% of the Te present in the glass prior to sintering/firing was in an oxidation state of TeO₄, 42% of the Te present in the glass prior to sintering/firing was in an oxidation state of TeO₃, and 1% of the Te present in the glass prior to sintering/firing was in an oxidation state of TeO₃₊₁. As described in U.S. Patent Documents 2024/0167320 and 2024/0167324, laser firing/sintering of the glass to form main seal layer 30 may cause much of the TeO₄ to transform/convert into TeO₃ and TeO₃₊₁, which is advantageous because it increases the material's absorption in the near infrared (e.g., 808 or 810 nm for example, which may be used for the laser during sintering/firing) which provides for increased heating efficiency and reducing the chances of significantly de-tempering the glass substrate(s) due to improved heating efficiency during firing/sintering.

In certain example embodiments, prior to firing/sintering, the glass for the main seal layer 30 may include tellurium oxide with the following stoichiometry/oxidation state ratio(s) in terms of what oxidation state(s) are used by the Te in the material (e.g., see Table 1B): TeO₄>TeO₃>TeO₃₊₁. But the laser sintering/firing of the main seal layer may then cause the Te stoichiometry ratios/states to change to the following during/after sintering/firing: TeO₃>TeO₄>TeO₃₊₁, which is advantageous in vacuum insulating panels as discussed above. The TeO₄ is a trigonal bipyramid structure, TeO₃ is a trigonal pyramid structure, and TeO₃₊₁ is a polyhedral structure. In certain example embodiments, due to optimized laser treatment for firing/sintering of the main seal layer as discussed herein, the TeO₄ may largely convert to TeO₃ and marginally to TeO₃₊₁ with increasing temperature with a concurrent increase in the number of Te═O sites resulting from cleavage within the network structure.

For example, the “Example” column in Table 3 indicates that 84% of the V present in the glass prior to sintering/firing was in an oxidation state of V₂O₅, 15% of the V present in the glass prior to sintering/firing was in an oxidation state of VO₂, and 1% of the V present in the glass prior to sintering/firing was in an oxidation state of V₂O₃. As described in U.S. Patent Document 2024/0167324, laser firing/sintering of the main seal layer 30 may cause much of the V₂O₅ to transform/convert into VO₂ and V₂O₃, which is advantageous because it increases the material's density and thus the hermiticity and durability of the seal (e.g., VO₂ results in a more dense layer than does V₂O₅). In certain example embodiments, it is desirable to reduce the V₂O₅ content in the final sintered/fired state of the main seal 30 because the glass network becomes more closed with decreasing V₂O₅ concentration, e.g., due to the reduction of non-bridging oxygen resulting in a higher density seal which improves water/moisture resistance, mechanical strength (adhesive and cohesive), and/or hermeticity. The Tg of the main seal 30 material may also slightly increase with a reduction in V₂O₅.

In certain example embodiments, the vanadium oxide in the glass for main seal layer material, before firing/sintering of the main seal layer 30, may include the following stoichiometry/oxidation state ratio(s): V₂O₅>VO₂>V₂O₃. But, for example, sintering/firing to form the main seal layer 30 may then cause the V stoichiometry ratios/states to change to the following during/after sintering/firing: VO₂>V₂O₅>V₂O₃, which is advantageous in vacuum insulating panels as discussed at least because it allows for higher density in the final seal layer. The V₂O₅ is an orthorhombic structure, VO₂ is a tetragonal structure, and V₂O₃ is corundum structured in the monoclinic C2/c space group. Vanadium is an insulator in a base form due to empty d-bands and acts as a network former/network modifier in the presence of tellurium oxide in the main seal material for layer 30 and/or the pump-out tube seal in certain example embodiments.

In certain example embodiments, as described in U.S. Patent Documents 2024/0167320 and 2024/0167324, an optimized type of laser processing may be used to sinter/fire the glass in the paste to form main seal layer 30 in a manner that causes one or more, or any combination, of the following to occur during and/or as a result of the sintering/firing: (a) stoichiometry values/oxidation states of Te in the glass to change from TeO₄>TeO₃>TeO₃₊₁ prior to laser firing/sintering, to TeO₃>TeO₄>TeO₃₊₁ following laser firing/sintering; (b) stoichiometry values/oxidation states of Te in the glass to change from TeO₄>TeO₃ prior to laser firing/sintering, to TeO₃>TeO₄ following laser firing/sintering to form layer 30; (c) stoichiometry values/oxidation states of vanadium (V) in the glass to change from V₂O₅>VO₂>V₂O₃ prior to laser firing/sintering, to VO₂>V₂O₅>V₂O₃ after laser firing/sintering to form the layer 30; (d) stoichiometry values/oxidation states of V in the glass to change from V₂O₅>VO₂ prior to laser firing/sintering, to VO₂>V₂O₅ after laser firing/sintering to form the layer 30; (e) the ratio TeO₄:TeO₃ to change from about 1.0 to 2.0 (more preferably from about 1.2 to 1.6, more preferably from about 1.3 to 1.5) prior to sintering/firing to from about 0.05 to 0.40 (more preferably from about 0.10 to 0.30, more preferably from about 0.13 to 0.22) after the laser sintering/firing to form the layer 30; and/or (f) the ratio V₂O₅: VO₂ to change from about 1.0 to 10.0 (more preferably from about 3.0 to 8.0, more preferably from about 4.5 to 7.0, with an example being 84:15=5.66) prior to sintering/firing to from about 0.10 to 0.90 (more preferably from about 0.20 to 0.80, more preferably from about 0.25 to 0.50, with an example being 25:63=0.39) after the laser sintering/firing to form the layer 30.

This main seal material(s) for layer 30 described above, or substantially the same material, may also be used for the pump-out tube seal 13, with or without a primer, in certain example embodiments, although other types of seals may also be used such as vanadium oxide based ceramic sealing glass or solder glass.

In certain example embodiments, in addition to the glass discussed above, the paste to be used for forming main seal layer 30 may also include at least one filler. The amount of filler may, for example, be from 1-40 wt. %, preferably 1-30 wt. %, more preferably 1-25 wt. %, of the paste and may have an average grain size (d50) of 5-30 μm, for example an average d50 grain size from about 15-30 μm, more preferably from about 20-30 μm, and most preferably less than about 25 μm. Mixtures of two or more grain size distributions (e.g., coarse: d50=15-30 μm and fine: d50=1-10 μm) may be used. The filler may, for example, comprise one or more of zirconium phosphates, dizirconium diorthophosphates, zirconium tungstates, zirconium vanadates, aluminum phosphate, cordierite, eucryptite, keatite, alkaline earth zirconium phosphates such as (Mg,Ca,Ba,Sr) Zr₄P₅O₂₄, amorphous silica, amorphous or substantially amorphous borosilicate glass, amorphous and/or substantially amorphous lithia aluminosilicate glass, mullite, or zircon, either alone or in any combination. In certain example embodiments the filler may comprise low expansion ceramic materials such as aluminum titanate, zirconium vanadium phosphates, petalite, either alone or in combination with other filler materials. In certain example embodiments the filler may also contain little or no zinc oxide and/or aluminum oxide, and may contain zinc oxide and/or aluminum oxide in the amounts/ranges identified above in Table 1 with respect to mol % and/or wt. % (e.g., when the filler is of or includes amorphous material, such as amorphous silica or substantially amorphous silica, amorphous or substantially amorphous borosilicate glass, amorphous and/or substantially amorphous lithia aluminosilicate glass, and/or Pyrex glass powder, or any combination thereof, for example). The use of amorphous or substantially amorphous material, such as amorphous or substantially amorphous silica, amorphous and/or substantially amorphous lithia aluminosilicate glass, and/or amorphous and/or substantially amorphous borosilicate glass, in the filler in technically advantageous in that amorphous or substantially amorphous silica for instance is a low expansion material and helps grade the CTE values of the seal layers 30-32 relative to the glass substrates in a desirable manner. In such example embodiments, the resulting seal layer 30 may also contain little or no zinc oxide and/or aluminum oxide, and may also contain zinc oxide and/or aluminum oxide in the amounts/ranges identified above in Table 1 with respect to mol % and/or wt. %. The paste may also include solvent and binder.

Main seal layer 30, and/or the primer layer(s) 31 and/or 32, is/are substantially free (no more than about 1%, more preferably no more than about 0.5%, wt. % or mol %) of and/or free of bismuth, lead and/or cadmium in certain example embodiments.

FIGS. 11a-11b illustrate an example material(s) that may be used for the primer layer(s) 31 and/or 32 in various example embodiments, including for example in any of the embodiments of FIGS. 1-9. However, other suitable materials, such as solder glass, other materials comprising bismuth oxide, and so forth, may be used for one or both primer layers 31 and/or 32 in various example embodiments.

Table 4 sets forth example ranges for various elements and/or compounds for this example primer material according to various example embodiments, for both mol % and weight %, prior to firing/sintering. In certain example embodiments, one or both of the primer layers 31 and/or 32 may comprise mol % and/or wt. % of the following compounds in one or more of the following orders of magnitude: boron oxide>bismuth oxide>silicon oxide, bismuth oxide>silicon oxide>boron, boron oxide>bismuth oxide>silicon oxide>titanium oxide, bismuth oxide>silicon oxide>boron oxide>titanium oxide, boron oxide>silicon oxide>titanium oxide>bismuth oxide, and/or silicon oxide>boron oxide>bismuth oxide, before and/or after formation of the hermetic edge seal 3. It will be appreciated that other materials may be used together, or in place of, those shown below, and that the example percentages may be different in alternate embodiments.

TABLE 4
(example primer material prior to firing/sintering)

| | | More | Most | | More | Most |
|---|---|---|---|---|---|---|
| | General | Preferred | Preferred | General | Preferred | Preferred |
| | (Mol %) | (Mol %) | (Mol %) | (Wt. %) | (Wt. %) | (Wt. %) |
| bismuth oxide (e.g., | 0.5-50% | 1-10% | 2-5% | 5-50% or | 10-40% or | 15-25% or |
| Bi₂O₃ and/or other | | | | 55-95% | 70-80% | 70-80% |
| stoichiometry) | | | | | | |
| boron oxide (e.g., | 10-50% | 20-40% | 25-35% | 10-50% | 20-40% | 25-35% |
| B₂O3 and/or other | | | | | | |
| stoichiometry) | | | | | | |
| Silicon oxide (e.g., | 0-50% or | 5-30% or | 15-25% | 0-50% | 5-30% | 15-25% |
| SiO₂ and/or other | 0-15% | 5-15% | | | | |
| stoichiometry) | | | | | | |
| Titanium oxide | 0-20% | 1-10% | 3-7% | 0-20% | 1-10% | 3-7% |
| (e.g., TiO₂ and/or | | | | | | |
| other stoichiometry) | | | | | | |
| Copper oxide (e.g., | 0-20% or | 1-15% | 2-10% or | 0-14% or | 0.7-10% | 1.3-7% or |
| CuO or other | 0.1-20% | | 2-5% | 0.1-14% | | 2-5% |
| stoichiometry) | | | | | | |

It is noted that “stoichiometry” as used herein covers, for example, oxygen coordination and oxygen state. Other compounds may also be provided in the primer material (e.g., see FIGS. 11a-11b). For example, on a weight basis, the primer material for one or both layers 31 and/or 32 may further comprise one or more of: 2-20% (or 2-7%) zinc oxide; 0-15% (or 2-7%) aluminum oxide; 0-10% (or 0-5%) magnesium oxide; 0-10% (or 0-5%) chromium oxide; 0-10% (or 0-5%) iron oxide; carbon dioxide; and/or other elements shown in the figures.

Table 5 sets forth example ranges for various elements and/or compounds for this example primer layer 31 and/or 32 material according to various example embodiments, for both mol % and weight %, after firing/sintering thereof and after formation of layers 31 and/or 32. It will be appreciated that other materials may be used together, or in place of, those shown below, and that the example percentages may be different in alternate embodiments.

TABLE 5
(example primer material after seal layer formation)

| | | More | Most | | More | Most |
|---|---|---|---|---|---|---|
| | General | Preferred | Preferred | General | Preferred | Preferred |
| | (Mol %) | (Mol %) | (Mol %) | (Wt. %) | (Wt. %) | (Wt. %) |
| bismuth oxide (e.g., | 0.5-50% | 1-12% | 4-9% | 5-70% or | 20-50% or | 30-40% or |
| Bi₂O₃ and/or other | | | | 55-95% | 70-80% | 70-80% |
| stoichiometry) | | | | | | |
| boron oxide (e.g., | 10-50% | 15-40% | 20-30% | 5-50% | 10-35% | 15-25% |
| B₂O3 and/or other | | | | | | |
| stoichiometry) | | | | | | |
| Silicon oxide (e.g., | 0-50% | 15-35% or | 22-30% | 0-50% | 5-35% | 15-30% |
| SiO₂ and/or other | or | 5-15% | | | | |
| stoichiometry) | 0-15% | | | | | |
| Titanium oxide | 0-20% | 3-12% | 4-11% | 0-20% | 3-12% | 4-11% |
| (e.g., TiO₂ and/or | | | | | | |
| other stoichiometry) | | | | | | |
| Copper oxide (e.g., | 0-20% or | 1-15% | 2-10% or | 0-14% or | 0.7-10% | 1.3-7% or |
| CuO or other | 0.1-20% | | 2-5% | 0.1-14% | | 2-5% |
| stoichiometry) | | | | | | |

Other compounds may also be provided in this primer material, as discussed above and/or shown in the figures. Certain elements may change during firing/sintering, and certain elements may at least partially burn off during processing prior to formation of the final edges seal 3. It will be appreciated that, as with other layers discussed herein, other materials may be used together, or in place of, those shown above and/or below, and that the example weight/mol percentages may be different in alternate embodiments. The ceramic sealing glass primer materials for layer(s) 31 and/or 32 are lead-free and/or substantially lead-free in certain example embodiments.

In certain example embodiments, the primer layer(s) 31 and/or 32, and/or the paste used to form same, may be considered to be boron-based, given that excluding oxygen, silicon, and carbon, boron has the largest magnitude in terms of mol % before and/or after firing/sintering. While other materials (e.g., bismuth based primers, solder glass, etc.) may be used for layer(s) 31 and/or 32 in certain example embodiments, boron-based material may be desirable for use as primer layer(s) 31 and/or 32 in certain example embodiments, for example when laser heating is used for sintering/firing the main seal layer 30, as follows. In certain example embodiments, on an elemental basis (not including oxides) and in terms of mol %, primer layer(s) 31 and/or 32 may have a ratio B/Bi, of boron (B) to bismuth (Bi), of from about 1.1 to 10.0, more preferably from about 2.0 to 6.0, and most preferably from about 2.5 to 4.5 (with an example being about 3.7), after firing/sintering of the main seal layer 30 and/or primer(s). In certain example embodiments, in terms of mol % after sintering/firing, primer layer(s) 31 and/or 32 may comprise at least two times as much B as Bi, more preferably at least about three times as much B as Bi, and/or may comprise at least about two time as much B oxide as Bi oxide, more preferably at least about three times as much B oxide as Bi oxide.

When copper oxide is used, it is noted that different stoichiometries/oxidation states of copper oxide (e.g., CuOₓ) have different absorption characteristics, as shown in FIG. 13 for example. For example, CuO has an absorbance peak at high wavelength(s) around 700-750 nm and a thermal conductivity of about 30-70 W/mK, whereas Cu₂O (same as CuO_{0.5}) has an absorbance peak at lower wavelengths(s) around 460-470 nm and a lower thermal conductivity (e.g. see FIG. 13). Metallic copper (x=0) has a much higher thermal conductivity than does CuO, and absorbs light at all wavelengths. Thus, when using CuOₓ as a thermal diffusivity/conductivity additive, “x” may be selected based on the wavelength of the laser 41 used to fire and/or sinter the glass to form layer 30. For example, if a 480 nm laser 41 is used to fire and/or sinter the seal material 30, then copper oxide additive may be of or include Cu₂O (same as CuO_{0.5}, where x=0.5) or similar stoichiometry, because this stoichiometry has a peak absorption close to the 546 nm wavelength. As another example, if an 808 nm laser 41 is used to fire and/or sinter, then copper oxide additive may be of or include CuO (where x=1) or similar stoichiometry, because this stoichiometry has a peak absorption closer to the 808 nm wavelength. As another example, if a 532 nm or 546 nm laser 41 is used to fire and/or sinter, then copper oxide additive may be of or include a mixture of CuO (where x=1) and Cu₂O (same as CuO_{0.5}, where x=0.5), or similar stoichiometry, because this mixture will realize a peak absorption around 600 nm and thus closer to the 532 nm and 546 nm wavelengths. Thus, in various example embodiments, for example and without limitation, copper oxide additive may be made up entirely or partially of CuO (where x=1), entirely or partially of Cu₂O (same as CuO_{0.5}, where x=0.5), entirely or partially of CuO_{0.8}, entirely or partially of CuO_{0.9}, entirely or partially of CuO_{0.4}, any combination of these, or any other suitable stoichiometry(ies)/oxidation state. In certain example embodiments, “x” in CuOₓ (or other metal oxide MOₓ, where M is the metal) may be based on the wavelength of the laser 41, so that for example a peak absorption of the CuOₓ (or other metal oxide MOₓ) is within about 150 nm of the laser's wavelength, more preferably within about 100 nm of the laser's wavelength.

Further details of the edge seal structure, dimensions of the edge seal and other components, characteristics of the edge seal and other components, materials, laser processing, and the manufacturing of the overall panel may be provided in one or both of U.S. Patent Documents 2024/0167320 and/or 2024/0167324, the disclosures of which are hereby incorporated herein by reference in their entireties.

FIG. 12 is a flowchart illustrating example steps in making a vacuum insulating panel according to various example embodiments, which may be used in combination with any embodiment herein. Steps 201-204 apply to one of the two substrates, while steps 205-209 apply to the other one of the substrates, and steps 210-213 apply when the substrates are mated to each other via clamping, sealing, and/or the like.

A substrate (e.g., substrate 1 in FIG. 2) is provided in step 201, and another substrate (e.g., substrate 2 in FIG. 2) is provided in step 205. The substrate in step 205 may have a low-E coating 7 provided thereon, which may be edge-deleted in step 206. A primer layer (e.g., 31 in FIG. 2) may be applied to the corresponding substrate (e.g., substrate 1 in FIG. 2) in step 202, whereas the other primer layer (e.g., 32 in FIG. 2) may be applied to the other substrate (e.g., substrate 2 in FIG. 2) in step 207. In various example embodiments, one or both ceramic sealing glass primer layers 31-32 may be boron oxide inclusive and/or bismuth oxide inclusive, and may be applied using silk screen printing, digital printing, pad printing, extrusion coating, ceramic spray coating or nozzle dispense methods. The primer layer(s) 31 and/or 32 may be deposited (e.g., in the form of a paste) to achieve a sintered width of about 10 mm around the periphery of the substrates. In certain example embodiments, one or both primer layers may be applied to the glass surface at a thickness from about 40% to 60% higher than the desired target thickness. In an example embodiment, each primer layer as initially deposited may have a solids content of about 75 wt %, solvent about 24 wt. %, and binder about 1 wt. %. The substrates, with respective primers thereon, may then be thermally heated to remove solvents in the material using one of the following substrate heating methods or a combination thereof: radiation, convection, induction, microwave or conduction. The substrates may be heated between 100 degrees C. to 250 degrees C. for 30 seconds to ten minutes to remove the solvents from the sealing glass material with an example temperature being 180 degrees C. for about 4 minutes. Substrates may then be thermally heated to remove organic resin materials in the sealing glass primer material using one of the following substrate heating methods or a combination thereof; radiation, convection, induction, microwave or conduction, such as for example to from 275 degrees C. to 400 degrees C. for 30 seconds to ten minutes with an example temperature being about 320 degrees C. for 6 minutes. The removal of the organic resin material from the primers may be referred to as ceramic sealing glass binder burnout. In steps 203 and 208, the substrates may then be thermally heated for thermally tempering the glass substrates and to sinter and fire the ceramic primer material to the desired physical thickness and material properties using one of the following substrate heating methods or a combination thereof: radiation, convection, induction, microwave or conduction. For example, the substrates 1 and 2 may be heated to from between 575 degrees C. to 700 degrees C. for 30 seconds to five minutes depending on the thickness of the substrates with an example temperature being 625 degrees C. at a rate of 30 seconds per mm of uncoated glass thickness and 60 second per mm of Low-E coated glass thickness. Thus, the primer layers 31-32 are fired/sintered when the corresponding glass substrates 1 and 2 are thermally tempered, in certain example embodiments, in steps 203 and 208. When heat strengthened glass is used instead of tempered glass, in certain example embodiments, the primer layers 31 and/or 32 may be sintered in a step that does not involve tempering. As an example, the primer layers may be dried at a temperature of about 180 degrees C. to substantially remove solvents in the sealing glass matrix using thermal heat, and then be thermally heated a temperature of about 320 degrees C. to burn out the resin binders that provide the carrier vehicle for the sealing glass paste material, and then be sintered at 625 degrees C. while the glass substrates 1, 2 are thermally tempered to achieve desired properties.

In certain example embodiments, the sintered/fired primer layers 31-32 may be opaque or semi-opaque to visible light with an optical density >0.80 or >0.250. In an example embodiment, a sinter/fired primer may have a physical thickness between about 20 to 240 microns, more preferably from about 160 microns to about 240 microns, with an example thickness(es) of about 145 or 200 microns for primer layer 32, and about 45 microns for primer layer 31. The primer layer on one substrate may be deposited substantially thicker than the primer layer on the other substrate. The primer layer(s) may be opaque or substantially opaque to laser energy over the spectral range of 370 nm to 1500 nm above a minimum thickness, but may transmit a reasonable amount of laser energy at thicknesses below 60 microns for example. In certain example embodiments, primer layer 31 may be transmissive to from about 1-35% of a laser beam at one or more of 808, 810, or 1064 nm. The total perimeter seal thickness may be about 280 microns. The thicknesses of the thick primer layer 32, thin primer layer 31 and main seal layer 30 can be optimized to attain desired processing conditions.

In certain example embodiments, in steps 203 and 208, the primer layers 31 and 32 may bond to and/or diffuse into the respective glass substrates upon which they are located since the glass substrates 1, 2 are above the glass softening point, and create a high adhesion strength to the glass substrates. Interdiffusion of the primer layer(s) into the respective glass substrate(s) results in a high adhesion strength to the glass substrates, as for example SiO₂ in the primer layer(s) bond to a silicon-rich layer in a soda lime silicate float glass in certain example embodiments. The primer layers may have a CTE of about 8.0-8.80×10⁻⁶ or about 8.2-8.35×10⁻⁶, and may act as a CTE buffer between the glass substrates with a CTE of about 8.8-9.2 (e.g., about 9.0×10⁻⁶) and the main seal layer 30 with a CTE of about 7.0-8.4×10⁻⁶ or 7.2-8.2×10⁻⁶ (e.g., about 7.60×10⁻⁶) in certain example embodiments.

In step 204, paste for forming ceramic sealing glass main layer 30 (e.g., which may be Te oxide based or inclusive) may then applied to one of the glass substrates over the primer layer (e.g., over primer 31, or over primer 32), such as via silkscreen printing, ceramic spray, extrusion coating, digital printing, pad printing, extrusion, nozzle dispense or other commercially available ceramic sealing material application methods. As mentioned above, the paste may include glass, filler, solvent, and binder. The substrate may be thermally heated to remove solvents in the material using one of the following substrate heating methods or a combination thereof; radiation, convection, induction, microwave and/or conduction. The substrate may be heated between 100 degrees C. to 250 degrees C. for 30 seconds to ten minutes to remove solvents from the material with an example temperature being about 180 degrees C. for about 4 minutes.

After the spacers are provided on a substrate in step 209, the two glass substrates 1 and 2 may then be mated together and clamped around the periphery of the vacuum insulated unit to create a mated unit in step 210. The pump-out tube 12 and preform 13 may be applied to the substrate having recess 15 between steps 210 and 211 in certain example embodiments. The mated unit may then be thermally heated to burn out the resin binders that provide the carrier vehicle for the sealing glass paste material and then pre-glazed at a temperature of about 370 degrees C. to impart mechanical strength properties and performance between the main layer and primer layer(s). For example, mechanical adhesion strength after the mated unit has been pre-glazed may be about 30 kg per cm² and can be up to 100 kg per cm². For example, the perimeter of the vacuum insulated glass unit may be physically clamped with a controlled pressure to assist in setting the final thickness/height of the edge seal 3. The substrates may then be thermally heated to remove organic resin materials in the paste using one of the following substrate heating methods or a combination thereof; radiation, convection, induction, microwave or conduction. The binder burnout duration may be optimized so that much or substantially all binder is removed from the main layer 30 and the target density and/or porosity may be achieved. The mated unit may be heated to about 370 degrees C. to pre-glaze in certain example embodiments. The pre-glaze may one or more of: (1) create a strong mechanical bond between the primer layer(s) and the main seal layer; (2) the main seal layer may reach or substantially reach its target thickness so the mechanical clamps may be removed prior to laser sintering; and/or (3) reduce process requirements for the laser to enable high linear rates.

In step 211, the mated unit may be pre-heated using an ambient temperature of about 320 degrees C. (e.g., see pre-heating discussion above). In step 212, a laser (e.g., an 800 nm, 808 nm, 810 nm, or 940 nm continuous wave laser) 41 may then be used to locally and selectively sinter/fire the material for the main seal layer 30. For example, the laser 41 and/or laser beam 40 may move around the periphery of the vacuum insulated unit using an XYZ gantry robot at a defined linear rate to wet the interface between the fully sintered primer layers 31, 32 and the pre-glazed main seal layer 30, fire and/or sinter the main seal layer 30 to its final state (e.g., thickness, density and porosity) to reduce the size of air pores in the main seal layer 30 and/or at the main layer to primer interface. The laser linear speed, laser power, laser beam size, laser irradiation time, and/or laser thermal decay time may be optimized to achieve desired physical, chemical and/or mechanical properties. In step 213, the vacuum insulating panel is then evacuated to a low pressure using the pump-out tube 12, the tube closed off, and a cap 14 may be applied thereto.

It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). Terms, such as “first”, “second”, and the like, may be used herein to describe various components. Each of these terminologies is not used to define an essence, order or sequence of a corresponding component but used merely to distinguish the corresponding component from other component(s). For example, a “first” component may be referred to as a “second” component, and similarly, the “second” component may be referred to as the “first” component. “Or” as used herein may cover both “and” and “or.”

It should be noted that if it is described that one component is “connected”, “coupled”, or “joined” to another component, at least a third component(s) may be “connected”, “coupled”, and “joined” between the first and second components, although the first component may be directly connected, coupled, or joined to the second component. Thus, terms such as “connected” and “coupled” cover both direct and indirect connections and couplings.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or populations thereof.

The word “about” as used herein means the identified value plus/minus 5%.

“On” as used herein covers both directly on, and indirectly on with intervening element(s) therebetween. Thus, for example, if element A is stated to be “on” element B, this covers element A being directly and/or indirectly on element B. Likewise, “supported by” as used herein covers both in physical contact with, and indirectly supported by with intervening element(s) therebetween.

Each embodiment herein may be used in combination with any other embodiment(s) described herein.

While the disclosure has been illustrated and described with reference to various example embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in combination with any other embodiment(s) described herein.

1. A method of making a vacuum insulating panel, the vacuum insulating panel comprising a first substrate, a second substrate, a plurality of spacers provided in a gap between at least the first and second substrates, and a seal, the seal comprising a seal layer; wherein the method comprises:
providing glass in a location for a seal, the glass to be used in forming the seal layer, and wherein the glass comprises:
tellurium oxide: from about 10-80 mol %;
aluminum oxide: from about 0-0.5 mol %;
zinc oxide: from about 0-10 mol %;
tungsten oxide: from about 0-0.5 mol %;
molybdenum oxide: from about 0-0.5 mol %;
bismuth oxide: from about 0-3 mol %;
wherein the glass has a Labino softening point (Tₛ) of less than 345 degrees C.,
heating the glass in order to form the seal layer; and
after forming the seal, evacuating the gap to a pressure less than atmospheric pressure.

2. The method of claim 1, wherein the glass has a Labino softening point (Tₛ) of less than 330 degrees C., and the seal layer has a CTE of from about 7.0 to 8.4×10⁻⁶ mm/(mm*deg. C).

3. The method of claim 1, wherein the glass comprises from about 20-75 mol % tellurium oxide, and wherein tellurium oxide has the largest mol. % of any metal oxide in glass and in the seal layer.

4. The method of claim 1, wherein the glass comprises from about 35-75 mol % tellurium oxide, and wherein tellurium oxide has the largest mol. % of any metal oxide in glass and in the seal layer

5. The method of claim 1, wherein the glass comprises from about 0-4 mol % zinc oxide.

6. The method of claim 1, wherein the glass comprises from about 0-2 mol % zinc oxide.

7. The method of claim 1, wherein the glass comprises from about 0-1 mol % zinc oxide.

8. The method of claim 1, wherein the glass further comprises from about 5-58 mol % vanadium oxide, and wherein a ratio of tellurium oxide/vanadium oxide in the glass is greater than 1 in terms of mol %.

9. The method of claim 1, wherein the glass comprises from about 10-45 mol % vanadium oxide.

10. The method of claim 1, wherein the glass comprises from about 20-40 mol % vanadium oxide and/or from about 0-1 mol % tungsten oxide.

11. The method of claim 1, where the glass comprises vanadium oxide, wherein tellurium oxide has the largest magnitude mol % of any metal oxide in the glass and the glass contains more tellurium oxide than vanadium oxide in terms of mol %, with tellurium oxide and vanadium oxide having the two largest magnitudes with respect to mol % of any metal oxides in the glass.

12. The method of claim 1, wherein the glass comprises from about 0-4% phosphorous oxide, in terms of mol %.

13. The method of claim 1, wherein the glass comprises from about 0-1% phosphorous oxide, in terms of mol %.

14. The method of claim 1, wherein the glass further comprises from about 0.5%-40%, more preferably from about 1-40%, more preferably from about 1-25%, more preferably from about 4-25%, more preferably from about 5-22%, more preferably from about 5-15% copper oxide, in terms of mol %.

15. The method of claim 1, wherein the glass further comprises from about 1-8 mol % titanium oxide.

16. The method of claim 1, wherein the glass further comprises from about 0.5-30%, more preferably from about 1-30%, more preferably from about 1-25%, more preferably from about 3-22%, more preferably from about 6-20%, more preferably from about 9-15% lanthanum oxide, in terms of mol %.

17. The method of claim 1, wherein the glass further comprises from about 1-20%, more preferably from about 1-15%, more preferably from about 3-15%, more preferably from about 3-10% yttrium oxide, in terms of mol %.

18. The method of claim 1, wherein the glass further comprises from about 1-40%, more preferably from about 1-25%, more preferably from about 5-22%, more preferably from about 5-15%, manganese oxide, in terms of mol %.

19. The method of claim 1, wherein the glass further comprises from about 1-20%, more preferably from about 1-15%, more preferably from about 3-15%, more preferably from about 2-10% boron oxide, in terms of mol %.

20. The method of claim 1, wherein the glass when initially provided in a location between at least the first and second substrates is part of paste to be heated, wherein the paste comprises the glass, a filler, a binder, and a solvent.

21. The method of claim 20, wherein the filler comprises at least one of: amorphous or substantially amorphous silica, amorphous or substantially amorphous borosilicate glass, magnesium alumino silicate glass, zinc alumino silicate glass, zirconyl phosphate, dizirconium diorthophosphate, zirconium tungstate, zirconium vanadate, aluminum phosphate, cordierite, eucryptite, ekanite, alkaline earth zirconium phosphate, mullite, zircon, or any combination thereof.

22. The method of claim 1, wherein the glass has a Labino softening point (Tₛ) of less than 326 degrees C.

23. The method of claim 1, wherein the glass has a Labino softening point (Tₛ) of less than 315 degrees C.

24. The method of claim 1, wherein the glass has a Labino softening point (Tₛ) from about 280-310 degrees C.

25. The method of claim 1, wherein the glass comprises from about 0-1 mol % bismuth oxide.

26. The method of claim 1, wherein the glass has a ratio LSPT/DSPT, of the Labino softening point (LSPT) to the Dilatometric softening point (DSPT), in degrees C., from about 1.05 to 1.45, more preferably from about 1.05 to 1.40, more preferably from about 1.05 to 1.25, more preferably from about 1.05 to 1.20, more preferably from about 1.108 to 1.17, and most preferably from about 1.10 to 1.15.

27. The method of claim 1, wherein the seal further comprises at least one primer layer comprising bismuth oxide and/or boron oxide.

28. The method of claim 1, wherein after the heating of the glass to form the seal layer, the seal layer comprises tellurium oxide which includes TeO₄ and TeO₃, and wherein the seal layer comprises more TeO₃ than TeO₄ in terms of mol % after the heating to form the seal layer.

29. The method of claim 28, wherein a ratio TeO₄:TeO₃ in the seal layer is from about 0.05 to 0.40 after the heating to form the seal layer.

30. The method of claim 1, wherein the seal layer comprises vanadium oxide including VO₂ and V₂O₅ after the heating to form the seal layer, and wherein more V in the seal layer is in a form of VO₂ than V₂O₅ after the heating to form the seal layer.

31. The method of claim 1, wherein the seal is an edge seal located at least partially between the first and second substrates.

32. The method of claim 1, wherein the seal is a pump-out tube seal.

33. The method of claim 1, wherein the first and second substrates are glass substrates.

34. The method of claim 1, wherein the first and second substrates comprise heat strengthened or tempered glass substrates.

35. The method of claim 1, wherein the panel is configured for use in a window.

36. A method of making a vacuum insulating panel, the vacuum insulating panel comprising a first substrate, a second substrate, a plurality of spacers provided in a gap between at least the first and second substrates, and a seal provided at least partially between at least the first and second substrates, the seal comprising a seal layer; wherein the method comprises:
providing glass in a location between at least the first and second substrates, the glass to be used in forming the seal layer, and wherein the glass comprises:
tellurium oxide: from about 20-75 wt. %;
vanadium oxide: from about 15-45 wt. %;
aluminum oxide: from about 0-5 wt. %; and
zinc oxide: from about 0-10 wt. %;
wherein the glass comprises less TeO₃ than TeO₄ in terms of mol % before heating to form the seal layer;
wherein the glass has a ratio LSPT/DSPT, of the Labino softening point (LSPT) to the Dilatometric softening point (DSPT), in degrees C., from about 1.05 to 1.25;
heating the glass in order to form the seal layer; and
after forming the seal layer, evacuating the gap to a pressure less than atmospheric pressure.

37. The method of claim 36, wherein the seal layer comprises more TeO₃ than TeO₄ in terms of mol % after the heating to form the seal layer.

38. Glass for use in forming a seal layer of a vacuum insulating panel, the glass comprising:
tellurium oxide: from about 20-75 wt. %;
aluminum oxide: from about 0-5 wt. %;
zinc oxide: from about 0-5 wt. %;
tungsten oxide: from about 0-1 wt. %;
molybdenum oxide: from about 0-1 wt. %; and
bismuth oxide: from about 0-1 wt. %.

39. The glass of claim 38, wherein the glass comprises from about 15-45 wt. % vanadium oxide.

40. The glass of claim 38, wherein the glass comprises from about 1-5 wt. % titanium oxide.

41. Glass for use in forming a seal layer of a vacuum insulating panel, the glass comprising:
tellurium oxide: from about 20-75 wt. %;
aluminum oxide: from about 0-5 wt. %;
zinc oxide: from about 0-5 wt. %;
tungsten oxide: from about 0-1 wt. %;
molybdenum oxide: from about 0-1 wt. %; and
wherein the glass comprises less TeO₃ than TeO₄ in terms of mol % before heating to form a seal layer of a vacuum insulating panel;
wherein the glass has a ratio LSPT/DSPT, of the Labino softening point (LSPT) to the Dilatometric softening point (DSPT), in degrees C., from about 1.05 to 1.25.
